(19) United States
(12) Patent Application Publication
(10) Pub. No.: US 2022/0198572 A1
(43) Pub. Date: Jun. 23, 2022

(54) SYSTEM FOR AUGMENTING THIRD PARTY DATA

(71) Applicant: Hippo Analytics Inc. dba Hippo Insurance Services, Palo Alto, CA (US)

(72) Inventors: Vijeyta Aggarwal, Los Altos, CA (US); Dalit Shahar, Sunnyvale, CA (US); Neta Krakover, Palo Alto, CA (US); Guy Mograbi, San Jose, CA (US); Aviad Pinkovezky, Mountain View, CA (US)

(21) Appl. No.: 17/560,044

(22) Filed: Dec. 22, 2021

Related U.S. Application Data
(60) Provisional application No. 63/130,111, filed on Dec. 23, 2020.

(51) Int. Cl. G06Q 40/08; G06Q 50/16; G06N 20/00

(52) U.S. Cl. CPC G06Q 40/08; G06N 20/00; G06Q 50/16

(57) ABSTRACT

A computer-implemented method includes accessing a first set of data from an online storage address of a third party server, the first set of data corresponding to a first floor plan of a real property, mapping, using a trained machine learning model and optical character recognition, the first set of data to corresponding attributes of a structured data format of a query engine, forming first structured data based on the mapped first set of data, forming attributes of a first query using the first structured data, and providing the first query to the query engine that is configured to generate a first quote of an insurance policy based on the attributes of the first query.

### CROSS-REFERENCE TO RELATED APPLICATIONS

The present application claims priority to U.S. Provisional Patent Application Ser. No. 63/130,111, filed Dec. 23, 2021, which is hereby incorporated by reference in its entirety.

### TECHNICAL FIELD

The subject matter disclosed herein generally relates to a special-purpose machine that augments data from multiple sources. Specifically, the present disclosure addresses systems and methods that access a continuous feed of data, structure the data using a trained model, and augment current data with the structured data for further processing.

### BACKGROUND

Companies use computer systems to generate quotes for the estimated costs for providing a particular set of services. For example, insurance companies use computerized quoting systems to provide quotes for proposed insurance coverages. When dealing with a large number of similarly situated customers, as when providing quotes to home builders who are selling similar homes in a newly built home community, quotes may be provided in bulk. However, existing bulk quoting implementations go through the full process of preparing a quote for each service and, as a result, are not optimized for bulk quoting. A single bulk quote may need to collect data individually from a variety of different vendors and will require multiple database transactions. Since the bulk quotes and the corresponding services production system usually share the same database resources, running a bulk quote process also impacts the performance of the services production system. In existing bulk quoting applications, the bulk quoting process may also result in a massive number of lead records created in the production database. Those potential quotes pollute the production database and are mixed with the “real” leads in the system. Existing bulk quoting processes also have a number of issues that prevent them from scaling to more partners and customers. For example, a manual intervention is required to ingest, run, and transmit files and the time to run may be as much as one hour per 10 k records.

Also, when providing insurance quotes to home builders who are dealing with a volume of customers, lead management becomes complicated as the home builder is the primary contact with the potential customer and the home builder is not in the position to manage the insurance leads generated for the respective customers. A lead management system is desired that manages the insurance leads for the home builder and manages the bulk quote process using data fed to the bulk quote system by the builder and by the insurance agent/broker.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure is deployed, in accordance with some example embodiments.

FIG. 2 is a block diagram illustrating a data augmentation application in accordance with one example embodiment.

FIG. 3 illustrates training and use of a machine-learning program, according to some example embodiments.

FIG. 4 is a sample workflow of a builder quoting service in accordance with one example embodiment.

FIG. 5 is a block diagram illustrating a quoting service engine in accordance with one example embodiment.

FIG. 6 is a block diagram illustrating the lead application programming interface (API) in accordance with one example embodiment.

FIG. 7 is a flow diagram illustrating a sample assignment algorithm in accordance with one example embodiment.

FIG. 8 is a block diagram illustrating communication of the builder server with the server of a partner insurance carrier to provide housing data for use by the server to generate codes for each housing product using a coding engine in accordance with one example embodiment.

FIG. 9 is a flow diagram illustrating a method for auto-populating fields of a query engine in accordance with one example embodiment.

FIG. 10 is a flow diagram illustrating a method for generating alternative coverage queries in accordance with one example embodiment.

FIG. 11 illustrates a routine 1100 in accordance with one embodiment.

FIG. 12 is block diagram showing a software architecture within which the present disclosure may be implemented, according to an example embodiment.

FIG. 13 is a diagrammatic representation of a machine in the form of a computer system within which a set of instructions may be executed for causing the machine to perform any one or more of the methodologies discussed herein, according to an example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural Components, such as modules) are optional and may be combined or subdivided, and operations (e.g., in a procedure, algorithm, or other function) may vary in sequence or be combined or subdivided.

Example embodiments described herein will be described in connection with data augmentation for a quote generation and management system of insurance services. It will be appreciated that the techniques described herein may be applied to systems for providing quotes for a number of different types of services where quotes may be used, such as homeowners insurance, rental insurance, auto sales, or any service which requires logic in order to generate a quote.

### Terminology

Agent—A person or entity that promotes and sells insurance policies.

Lead—A prospect for an insurance policy.

Partner—An entity with a customer list to be quoted. In the use case of home insurance quotes, the partner may be a home builder (also referred to as a third party) or a loan servicing entity.

Builder—a home builder or a property developer.

Prospect/Buyer—A customer of a partner. In the use case of home insurance quotes, the prospect may be a customer of a home builder or a loan servicing entity where the customer is acquiring property to be evaluated for a home insurance quote.

Overview

In the case of insurance services, loan servicers often partner with the insurance providers to provide insurance quotes for the property covered by the loan. The loan servicers have books of customers including their current home insurance premiums. It is desired on the part of the insurance company partner to provide insurance quotes to the loan servicer's customers based on the information available to the loan servicer and to send quotes and URLs that can be used to market to the loan servicers' customers with a pre-filled quote that can be readily accepted. Insurance companies may cooperate with partners such as home builders with very large customer portfolios where it is desired to provide bulk quotes for insurance services in order to interact with the consumers of the partners. For example, an e-mail campaign may be provided to the partner's customer that provides the customer with a link that may be selected to obtain a quote from an insurance company partner. The link also may be co-branded and embedded within the partner's website whereby the customer is re-directed from the partners' webpage to the insurance company partner upon selection of the link.

The partner also can display multiple options. For example, the partner may display multiple insurance service options where the insurance company partner is one of the options. For example, lenders may provide multiple insurance service options. In this case, everything is prepared in the insurance company partner's system. On the other hand, in the case of an agent, for example, the agent would access the insurance company partner's system via a portal, retrieve the customer information, and call the customer directly. This process saves many steps because the customers are pre-quoted and the agent does not have to complete a new flow for each customer.

On the other hand, in the case of builders, for example, it may be desirable to quote communities in the builder's portfolio. In this case, the user would choose a community and then everything is pre-filled based on the community and the model information provided by the builder. Information is already pre-filled except for the name of the customer. The homeowner may call the builder or the builder's insurance agency, and the builder or the builder's insurance agency already has the models and the price as well as the price for the corresponding insurance product.

To implement these and other related capabilities, a system is described herein that creates a quote by receiving a comma separated values (CSV) file with instructions for how to map a specific field and how to treat each column. A mapping in the file is created from the origin to a mapping within a system. Internal processing extracts (using machine learning models and optical character recognition OCR) address, personal information, coverages, estimate numbers, and details from the partner about the property to be insured. A dictionary of words and/or phrases for each column header may be used to match words or phrases in the column/header with a dictionary of words/phrases to make sure the columns/headers correspond. The fields may be analyzed to provide automatic mapping where appropriate. Conversely, manual mapping may be implemented with suggestions based on similarities. In example embodiments, the system may look at column headers and guess the attribute based on the name of the column header.

In one example embodiment, the system described herein provides a builder agency with a suite of services to power the workstream of offering, quoting and selling insurance policies through the builder agency. The system is not limited to a particular insurance carrier. Rather, the system supports insurance policies provided by any number of carriers that service a particular area. In sample embodiments, the system implements a workflow that enables the builder to provide community quotes by uploading data files relating to home models and generating quotes based on the model data. The model data information is reviewed and particular models are assigned to insurance carriers. Based on the model data, sales leads are uploaded and matched against the relevant insurance carrier. Sales leads are assigned to insurance agents, as appropriate, and emails are automatically generated that introduce the sales leads to the insurance agent and/or insurance agency and includes quotes generated for the associated home model. The system also manages the generation and flow of user consent forms for the offered insurance policies as well as managing user online purchase flow for the insurance policies. The system further allows the insurance agency's user to start a new quote of an insurance policy to a sales lead that called the agency. The process flow and related reporting features may be managed through a user-friendly dashboard.

In another example embodiment, the system described herein augments data from a third party (e.g., the builder) by accessing a continuous feed of data from the builder's database or website, parsing the data from the builder, scraping data using machine learning model to identify corresponding attributes or fields to generate structured augmented data, linking the structured augmented data to a corresponding record from the builder's database or website. In one example, the system generates metadata for the quote, the metadata indicating the online storage address of a third party server, and the first floor plan of the real property. The system appends the metadata to the first quote. In another example, the system applies a trained machine learning model to identify propensities of changes to the property based on buyers historical and custom modifications to the property from the builder, and to generate alternative quotes based on the propensities of changes.

In another example embodiment, a computer-implemented method includes accessing a first set of data from an online storage address of a third party server, the first set of data corresponding to a first floor plan of a real property, mapping, using a trained machine learning model and optical character recognition, the first set of data to corresponding attributes of a structured data format of a query engine, forming first structured data based on the mapped first set of data, forming attributes of a first query using the first structured data, and providing the first query to the query engine that is configured to generate a first quote of an insurance policy based on the attributes of the first query.

As a result, one or more of the methodologies described herein facilitate solving the technical problem of augmenting data from one source with data being mapped to corresponding fields or attributes, forming a structured data based on unstructured data source, and generating alternative queries based on a trained learning model. As such, one or more of the methodologies described herein may obviate a need for certain efforts or computing resources that otherwise would be involved in formatting and organizing non-uniform data from third parties. As a result, resources used by one or more machines, databases, or devices (e.g., within the environment) may be reduced. Examples of such computing resources include Processor cycles, network traffic, memory usage, data storage capacity, power consumption, network bandwidth, and cooling capacity.

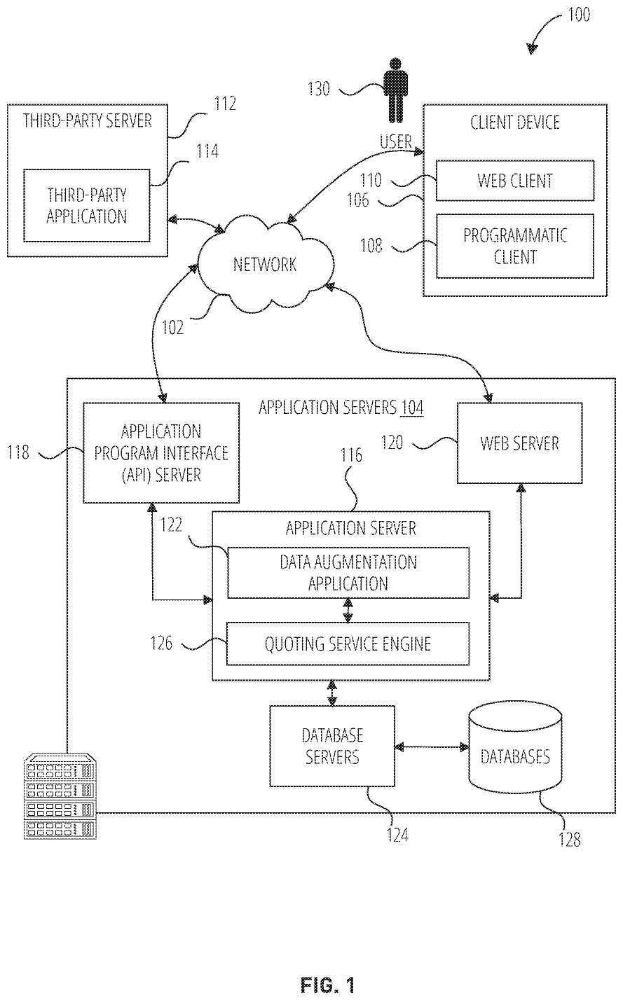

FIG. 1 is a diagrammatic representation of a network environment 100 in which some example embodiments of the present disclosure may be implemented or deployed. One or more application servers 104 provide server-side functionality via a network 102 to a networked user device, in the form of a client device 106. A user 130 (e.g., a buyer of a real property that is developed by a builder) operates the client device 106. The client device 106 includes a web client 110 (e.g., a browser operating a web version of an enterprise application), a programmatic client 108 (e.g., an insurance quoting application that is hosted and executed on the client device 106). In one example embodiment, the programmatic client 108 includes an insurance quoting application configured to receive field values from the user 130 to generate a query for a quote from a quoting service engine 126.

An Application Program Interface (API) server 118 and a web server 120 provide respective programmatic and web interfaces to application servers 104. A specific application server 116 hosts a data augmentation application 122 and the quoting service engine 126. Both the data augmentation application 122 and the quoting service engine 126 include Components, modules and/or applications.

The data augmentation application 122 accesses data from a third-party server 112 associated with a builder of a real property. In one example, the data augmentation application 122 retrieves data from the third-party server 112, parses the data, and maps the data to corresponding fields of a structured data format of a query for the quoting service engine 126. For example, the data augmentation application 122 uses a trained machine learning model to map the data (e.g., specifications of a floor plan) to the structured data format. The data augmentation application 122 trains a machine learning model based on features of data (e.g., floor plans, specifications of a floor plan, dimensions, types of appliances, types of materials, house features, types of roof, foundations, etc.) from the third-party server 112. The data from third-party server 112 may be stored in databases 128. The features may include keywords, labels, dimensions, values, attributes in the training documents/data. The data augmentation application 122 uses the machine learning model to classify the features and map them to corresponding attributes of a quoting query.

In another example, the data augmentation application 122 performs an OCR operation of the data to auto-populate fields in the query. In another example, the data augmentation application 122 receives insurance query data from the client device 106, augments the insurance query data with the mapped data from the third-party server 112, and provides the augmented insurance query data to the quoting service engine 126. In another example, the data augmentation application 122 receives insurance query data from the client device 106, augments the mapped data from the third-party server 112 with the insurance query data, and provides the augmented mapped data to the quoting service engine 126.

The quoting service engine 126 receives a quoting query from the data augmentation application 122. The quoting query includes values of attributes based on the mapped data from the third-party server 112 and/or the client device 106. The quoting service engine 126 is configured to generate a quote based on the values of the attributes in the quoting query.

In one example embodiment, the web client 110 communicates with the quoting service engine 126 and data augmentation application 122 via the programmatic interface provided by the Application Program Interface (API) server 118. In another example embodiment, the data augmentation application 122 augments data from the third-party server 112 and/or the client device 106 and provides the augmented data (formatted to the structured data format of the query) to the quoting service engine 126. The quoting service engine 126 generates a quote based on the augmented data and provides the quote to the client device 106 and/or the third-party server 112.

The application server 116 is shown to be communicatively coupled to database servers 124 that facilitates access to an information storage repository or databases 128. In one example embodiment, the databases 128 includes storage devices that store documents to be processed by the data augmentation application 122 and the quoting service engine 126. For example, the databases 128 include a library of data sets (e.g., training floor plans documents, floor plans specifications, dimensions, real property features, real property geographic location/region, structure data format of the quoting service engine 126).

Additionally, a third-party application 114 executing on the third-party server 112, is shown as having programmatic access to the application server 116 via the programmatic interface provided by the Application Program Interface (API) server 118. For example, the third-party application 114, using information retrieved from the application server 116, may supports one or more features or functions on a website hosted by the third party. For example, the third-party application 114 provides a continuous stream of updated specification data related to properties built by the builder.

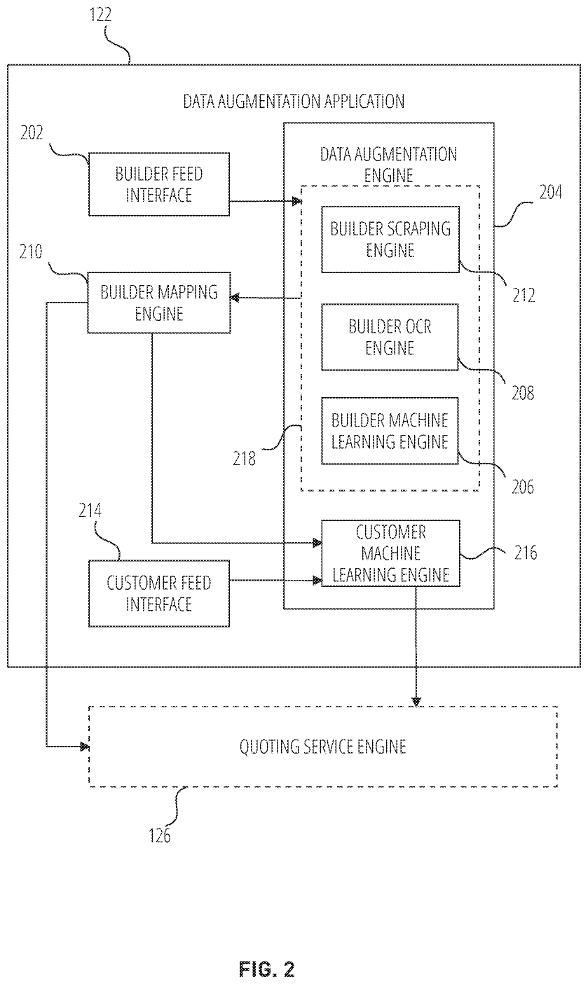

FIG. 2 is a block diagram illustrating the data augmentation application 122 in accordance with one example embodiment. The data augmentation application 122 includes a builder feed interface 202, a data augmentation engine 204, a builder mapping engine 210, and a customer feed interface 214.

The builder feed interface 202 accesses the third-party server 112 to retrieve data from the third-party server 112. For example, the builder feed interface 202 accesses the website of a builder (hosted on the third-party server 112). The builder feed interface 202 provides the data to the data augmentation engine 204.

The data augmentation engine 204 includes a builder sub-engine 218 and a customer machine learning engine 216. The builder sub-engine 218 augments data from the builder feed interface 202 and maps the augmented data to a structured data format associated with the quoting service engine 126. In one example, the builder sub-engine 218 includes a builder scraping engine 212, a builder OCR engine 208, and a builder machine learning engine 206. The builder scraping engine 212 scrapes the data from the website of the builder and scans the text and images from the pages of the website. In one example, the builder OCR engine 208 applies an OCR procedure to the text. The builder machine learning engine 206 uses a trained learning model to identify content from the website of the builder. For example, the builder machine learning engine 206 identifies names of models, floor plans, dimensions, features of a model or floorplan, and detects keywords. The data augmentation engine 204 provides the extracted images and text to the builder mapping engine 210.

The builder mapping engine 210 maps the extracted images and text from the data augmentation engine 204 to a structured data format of the quoting service engine 126. For example, the builder mapping engine 210 identifies the square footage of a floor plan from the data augmentation engine 204 and maps it to a corresponding house size attribute/field of the structured data format. The builder mapping engine 210 provides the structured data to the customer machine learning engine 216 and the quoting service engine 126.

The customer machine learning engine 216 receives customer data from customer feed interface 214. The customer feed interface 214 receives the customer data from the client device 106. For example, the customer data indicates a selected optional fourth bedroom on builder floor plan A. The customer machine learning engine 216 augments and updates the structured data (for builder floor plan A) from the customer machine learning engine 216 with the customer data from customer feed interface 214 (e.g., updates number of bedrooms attribute from three bedrooms to four bedrooms). The customer machine learning engine 216 provides the updated structured data to the quoting service engine 126.

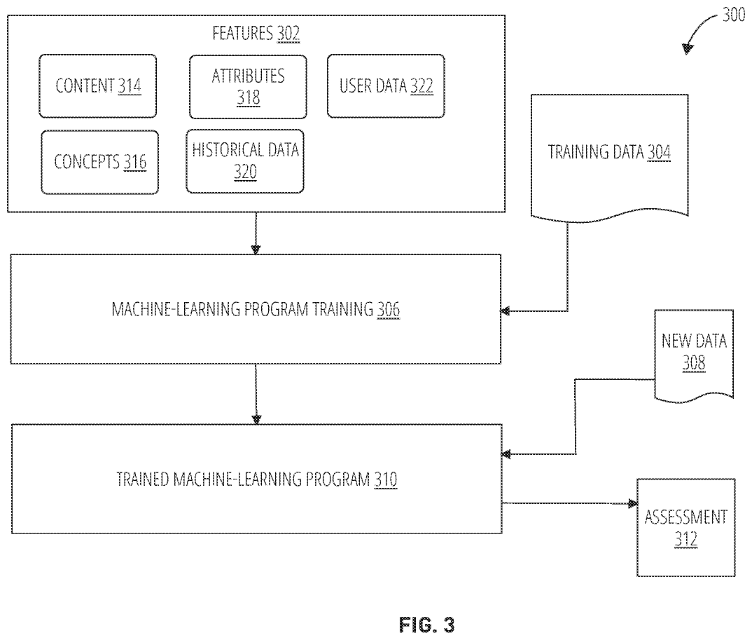

FIG. 3 illustrates training and use of a machine-learning program 300, according to some example embodiments. In some example embodiments, machine-learning programs (MLPs), also referred to as machine-learning algorithms or tools, are used to perform operations associated with searches.

Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data 304 (e.g., specification floor plans of real properties developed by a builder) in order to make data-driven predictions or decisions expressed as outputs or assessments (e.g., assessment 312—such as whether data value corresponding to a particular attribute: size of the real property, type of foundation, type of roof). Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring section breaks and keywords.

Two common types of problems in machine learning are classification problems and regression problems. Classification problems, also referred to as categorization problems, aim at classifying items into one of several category values (for example, type of foundation, type of roof). Regression algorithms aim at quantifying some items (for example, by providing a value that is a real number).

The machine-learning algorithms use features 302 for analyzing the data to generate an assessment 312. Each of the features 302 is an individual measurable property of a phenomenon being observed. The concept of a feature is related to that of an explanatory variable used in statistical techniques such as linear regression. Choosing informative, discriminating, and independent features is important for the effective operation of the MLP in pattern recognition, classification, and regression. Features may be of different types, such as numeric features, strings, and graphs.

In one example embodiment, the features 302 may be of different types and may include one or more of content 314 (e.g., specifications of a particular floor plan), concepts 316 (e.g., keywords), attributes 318, historical data 320 and/or user data 322 (e.g., user-selected type of flooring), merely for example.

The machine-learning algorithms use the training data 304 to find correlations among the identified features 302 that affect the outcome or assessment 312. In some example embodiments, the training data 304 includes labeled data, which is known data for one or more identified features 302. With the training data 304 and the identified features 302, the machine-learning tool is trained at machine-learning program training 306. The machine-learning tool appraises the value of the features 302 as they correlate to the training data 304. The result of the training is the trained machine-learning program 310.

In one example embodiment, for both models (e.g., “section boundary” and “section title”), the machine-learning program training 306 trains a deep neural network (DNN) with the following layers: Embedding→(Convolutional, MaxPooling)×2→Dropout→Dense→Dense. In the “section boundary” model, the output of the trained machine-learning program 310 is a binary classifier that determines the probability that a particular data value corresponding a number of bedrooms.

In another example embodiment, other alternative implementation of the machine-learning program training 306 include rule-based approaches, unsupervised learning or other supervised machine learning methods (e.g., decision trees, support vector machines). Alternative embodiments of the machine-learning program training 306 include using language generation models, such as BERT or GPT-2.

When the trained machine-learning program 310 is used to perform an assessment, new data 308 (e.g., from other builders) is provided as an input to the trained machine-learning program 310, and the trained machine-learning program 310 generates the assessment 312 (e.g., mapped structure data) as output.

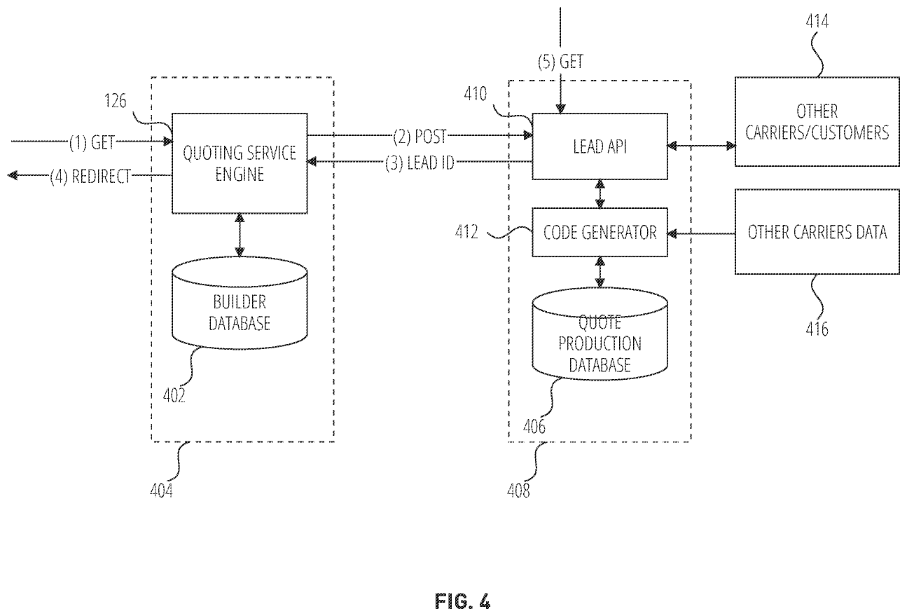

FIG. 4 is a sample workflow of a builder quoting service in accordance with one example embodiment. As illustrated, the workflow starts by an entity requesting at (1) a quote (GET <bq-service>/v1/quote/id) from a quoting service engine 126 associated with a builder database 402 on a builder server 404. The quoting service engine 126 posts the requested quote (POST <prod>/v1/quote/copy{quote}) at (2) to the lead API 410 of the production system 408 operated by a particular insurance carrier or the builder, which further includes code generator 412 and quote production database 406. At (3), the lead API 410 provides a created lead id from the quote production database 406 and a code generated by the code generator 412 to the quoting service engine 126, which redirects the lead id and the code to the quote requesting entity (redirect <prod>/v1/lead/id) at (4). The redirected lead id and code are, in turn, redirected at (5) to the production lead in the lead API 410 (GET <prod>/v1/lead/id) for storage in the quote production database 406.

Existing bulk quote implementations use the lead API 410 by mimicking the steps to create a quote. Since in the builder quote flow all the input information may be known upfront, the quoting flow may be rewritten to optimize for multiple quotes so that each step may be performed (e.g., input data validation, calls to data-vendors, quoting) only once. The ideal rating API needed for this quote flow may include only one interface which is a quote method. In sample embodiments of the type described below, this quote method may be called by the builder quoting service 110 and will get the builder data reports and reports from insurance agents as an input. It will be the responsibility of the builder quoting service 110 to cache and retrieve these reports. The lead API 410 will return a lead that will be saved in the builder database 402.

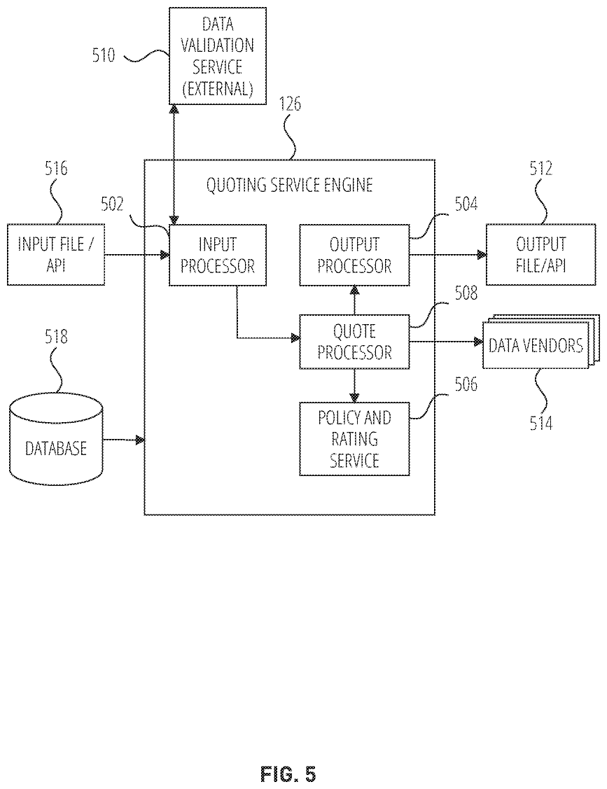

FIG. 5 is a block diagram illustrating a quoting service engine in accordance with one example embodiment. The quoting service engine 126 may start with an input from an external partner, in the case of an example implementation, an Amazon Web Services S3 may be used as file storage for input files. However, it will be appreciated that the quoting service engine 126 may be initiated using API calls. Secure File Transfer Protocol (SFTP) uploads, emails, and the like. In such an embodiment, an input file/API 516 (e.g., an S3 input file) may be uploaded to a memory (e.g., an S3 bucket) of input processor 502 as a builder file containing data relating to homes being built, purchase prospects, and the like. The input file/API 516 may be added to a Simple Notification Service (SNS) topic, and the input file/API 516 may include message data including a file path, a partner ID, quote global parameters, etc. The quoting service engine 126 may be triggered by a script that adds a message to a builder quote new file queue (e.g., a Simple Queue Service (SQS) queue). For example, the script may be a simple hypertext transfer protocol (HTTP) payload template that calls a route on the SNS message service. The script may be run manually, get the file's path, the partner id, and the builder quote global parameters, and may add a message to a builder quote new file (SQS) queue. The message added to the builder quote new file queue may include the file's path, the partner id, and the builder quote global parameters.

Once an input has been received by the quoting service engine 126, it is processed by input processor 502. The input processor 502 splits the input into individually processable quote records and assigns a job ID to each builder quote record. In addition, the input processor 502 validates every builder quote record to make sure that it is workable. Examples for validations include format validation (phone numbers, e-mail addresses, etc.) that may be performed by the input processor 502 and third party validations performed by a data validation service (external) 510 (e.g., residential street address validation, which can be validated against the U.S. Postal Service address database hosted by an external party). When the input processor 502 completes validation, each builder quote record may be stored in a database 518 with its validation result. In example embodiments, the database 518 corresponds to the builder database 402 in FIG. 4 and can be implemented using conventional memory storage, queues, and the like.

In example embodiments, the input file validation process initiates a builder quote input validation process whereby the input processor 502 validates the organization by organization ID through a hypertext transfer protocol (HTTP) call to the data validation service (external) 510 through route/v1/bulk-quotes/organization stored in the quote production database 406. The input processor 502 also validates builder quote parameters, and a builder quote record is created and stored in a builder quote queue associated with the database 518. The input processor 502 also may read a CSV file containing the file's path, partner id, and the builder quote global parameters line by line. For each line, the input data may be validated and the addresses for the individuals in the CSV file may be checked by, for example, calling a routine (e.g., US Postal Service database) to validate the addresses. The input processor 502 may further check to determine if a policy/lead exists. HTTP calls to the production system 408 may be avoided by instead using a read-only builder quote production database 406. The builder quote, with message data including the quote id, also may be stored in a quote pending queue of the database 518.

Once an individual quote record has been validated (other records for the same job can still be processing for validation), it is picked up by the quote processor 508, which is responsible for multiple steps in generating a builder quote, all of which can be performed in parallel for different states of the quote records.

The quote processor 508 takes a validated quote record provided by the input processor 502 and retrieves external data for the quote record from data vendors 514. For example, when the quote records relate to home insurance services, the data from the data vendors 514 may include information such as fire risk. Of course, the data vendors 514 may provide different types of information for different types of services subjected to builder quoting as described herein. Since some external data vendors 514 have rate limitations for their APIs, the number of quote processor 508 that may process this state may be programmatically limited by the quoting service engine 126 to accommodate such restrictions.

Once data has been pulled from data vendors 514 for a builder quote record, the data becomes ready for a quote rating. The quote processor 508 may read the builder quote from a quote pending queue of the database 518 and call a property/casualty insurance data analytics provider (e.g., Verisk) for quotes for rebuilding costs and the like. An existing cache of the analytics reports may be improved by adding override parameters to the cache key along with the address. The state of the quote record may be updated using a builder quote data microservice. If some of the calls time out, the state may be updated to VALIDATED and returned to a builder quote quoting queue. The quote processor 508 may further call a policy and rating service 506 to generate an initial rating (e.g., insurance premium rating) for the quote record using the input that was validated by the input processor 502 and the data that was retrieved from the data vendors 514. The quote processor 508 may further update the state of the quote by calling a guilder quote data microservice to get a quote from a property service and/or data vendors 514.

The policy and rating service 506 may provide one of two outcomes: either the policy and rating service 506 is able to rate the quote record, in which case the quote record would become eligible for a quote, or the quote record is rejected for rating based on internal business rules (e.g., risk modeling). When the quote record is rejected, no further processing is performed for that quote record. However, if the quote record is eligible for quoting, the quote processor 508 retrieves a credit/insurance score associated with the customer that will be used later for a final rating (e.g., final insurance premium rating). If a credit score is not available from the policy and rating service 506, the quote record is marked as a “no hit” and the process continues.

Once credit/insurance score information is available for a quote record, the quote processor 508 takes all of the gathered information and re-runs the policy and rating service 506 with the gathered information to generate a final quote (e.g., final insurance premium quote). The quote may be stored with the quote record in the database 518 and is marked as complete.

While quotes are being generated, the output processor 504 may periodically retrieve the status for all quote records within a specific job using the job ID. If all quote records for that job are either completed or rejected, the job is complete. Once the output processor 504 identifies that a job has reached completion, it may combine all the records for that job into a single output bundle, which can be a file or any other data format. The output processor 504 may read all the associated quotes from the processed builder quote queue and combine them into an output file/API 512 (e.g., S3 output file) that can be shared with the partner. The single output bundle is sent as output file/API 512 or otherwise made available via an API to the partner's API through an API call, an S3 upload, and SFTP upload, via email, or the like.

In example embodiments, the quote processor 508 further implements a cron job that checks if all addresses have been processed. The cron job runs periodically (e.g., every minute) and calls a route on the builder quote data microservice to count the number of quotes with the state identified as quoted or rejected. If the total count equals the total number of addresses (number of addresses on the associated builder quotes record), a message is added to the processed builder quote and stored in a processed builder quote queue of the database 518.

In example embodiments, a plurality of builder quotes may be implemented as:

Builder Quotes Model

{
id: UUID,
organization_id,
input_file_path,
output_file_path,
parameters: JSONB,
number_of_address,
state: IN_PROCESS|DONE|REJECTED_WITH_ERROR,
}

In the example embodiments, the quote model may be implemented as:

Quote Model

{
id: UUID,
builder_quotes_id,
input_parameters: {street, street2, city, zip, state,
. . .overrides},
state: NEW|VALIDATED|QUOTED|REJECTED
// The structure of the following should be aligned with the
Lead model
personal_info: JSONB,
property_data: JSONB,
adjustments: JSONB,
optional_coverages: JSONB,
insurance_score: JSONB,
quote: JSONB,
}

In the example embodiments, the API end points (“service routes”) may be implemented as follows:

Service Routes

// External routes. Can be accessed by authorized agents
POST /v1/start-builder-quotes-pipeline
{filepath, partnerId, parameters}
GET /v1/builder-quotes/id
GET /v1/quote/id
// Internal routes. Should be only accessible within the
builderquote service landscape
POST /v1/builder-quotes
{filepath, partnerId, numberOfAddresses, parameters}
PATCH /v1/builder-quotes/id
{state}
POST /v1/quote
{address, personalInfo, parameters}
PATCH /v1/quote/id
{prefill, quote}

In an example embodiment, the quoting service engine 126 may be deployed by implementing a container orchestration system, such as Kubernetes or terraforms, for automating the application deployment, scaling, and management of the application containers across clusters of hosts.

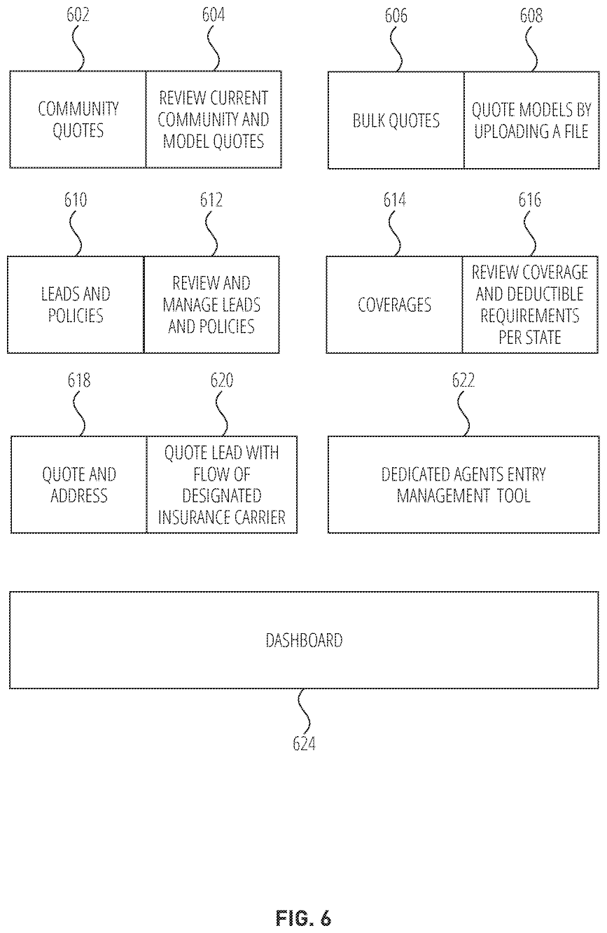

FIG. 6 is a block diagram illustrating the lead API 410 in accordance with one example embodiment. As illustrated, the lead API 410 may use tiles to implement the following entry points for new communities being built by the builder:

Community Quotes:
H1: community quotes 602
H2: review current community and model quotes 604

These entry points take the user to the community quotes page, where the quotes and assignments to insurance agencies can be reviewed.

Bulk Quotes:
H1: bulk quotes 606
H2: quote models by uploading a file 608

These entry points take the user to a bulk quote process of the type described, for example, in U.S. patent application Ser. No. 16/983,809, filed Aug. 3, 2020, and entitled “Batch Processing for Bulk Quotes Service,” which is assigned to the current assignee and incorporated herein by reference.

Leads and Policies:
H1: leads and policies 610
H2: review and manage leads and policies 612

These entry points take the user to the leads page, where the leads and/or policies can be reviewed and managed.

Coverages:
H1: coverages 614
H2: review coverage and deductible requirements per state 616

These entry points take the user to the coverages page, where the coverage assumptions that were created by the insurance carrier can be reviewed (and can be modified by a user of the insurance carrier).

Quote an Address:
H1: quote and address 618
H2: quote lead with flow of designated insurance carrier 620

These entry points take the user to the producer quote and purchase flow for particular policies to be offered by the builder based on model-specific quotes.

A dashboard 624 enables each insurance agent to see relevant data relating to, for example, policies issued this month or last month, how many houses were closed this month or last month for each builder, closing rate of this month or last month (policies issued divided by the number of houses closed over the same time period), and the like.

A dedicated agents entry management tool 622 also may be provided that enables insurance agents to set up an account in the system via a configuration file including the agent's identification, contact information, and the agent's territories.

### Communities Bulk Quote Process

To initiate bulk quotes for a community, “bulk quotes” is selected in the lead API 410, and an input file is provided from the code generator 412 that includes, for example, a unique identifier for the community in the form of a “Community Code”+“Community Phase” and a unique identifier for the model/plan in the form of a “ModelPlanCode”+“ModelElevationCode.” As a result, the absolute product identifier would be “Community Code”+“Community Phase”+“ModelPlanCode”+“ModelElevationCode.” This information may be maintained by the builder database 402 and/or the quote production database 406.

In a first sample use case, it is assumed that a quote is to be generated for insurance policies including a required coverage amount for a given community under development by a builder. In this example, all or part of the following information would be provided to the coding engine by the quoting service engine 126:
CommunityName;
CommunityAddress;
CommunityCity;
CommunityCounty;
CommunityState;
CommunityZip;
CommunityYearBuilt (default is current year);
CommunityProtectionClass (community's Public Protection Class (PPC));
ModelName;
ModelPolicyType (e.g., whether the model is a house or a condo);
Division Name (used to match model (and leads who purchased it) to agent);
NumberOfUnits (number of family units for this property);
SalesPrice (the price the model is listed for (or was sold for));
RoofMaterial (roof material for the model);
ProfessionallyMonitoredFireAlarm (yes or no);
ProfessionallyMonitoredTheftAlarm (yes or no);
GatedCommunity (yes or no);
InteriorSprinklers (yes or no);
StormShutters (yes or no); and/or
HOA (whether community is part of a homeowners association).

Any other parameters may be provided that may be used by the insurance carrier for quote generation for the given community.

In a second sample use case, it is assumed that a quote is to be generated for insurance policies including a coverage amount to be offered by one or more insurance carriers for a given community under development by the builder. In this example, in addition to the information requested in the first sample use case, all or part of the following information also would be provided:
ModelSquareFootage (Square footage of livable area in quoted model);
NumberOfStories;
ConstructionType (e.g., frame, brick veneer, masonry, concrete, steel);
RoofShape (e.g., gable, hip, flat, shed, custom, gambrel, mansard);
NumberOfFireplaces;
NumberOfBedrooms;
NumberOfBaths;
FoundationType (e.g., slab, basement);
GarageType (attached/built in, detached); and/or
GarageSize (number of cars).

Any of a number of data sources may be used to acquire this information. For example, Verisk 360Value may be used for the coverage amount calculation. Coverage and deductible amounts may be determined based on the enforced coverages first, if such values were set. If not, the quoting process may use default values. In addition, the community address may be used to pull a Fireline score that may be used for the community quotes. This information may be stored in the builder database 402 and/or the quote production database 406.

In a sample embodiment, the following assumptions may be made for a standard HO-3 (Homeowners Policy Special Form 3) homeowners insurance policy unless better data is available:
Date of Birth (DOB);
Insurance score;
No past claims;
Territory is zip code based;
General deductible in Texas; and/or
Wind and hail deductible in Texas.

In the sample embodiments, discounts may be applied by default. Such discounts may include, for example, auto insurance policy discount in states where it is applicable, recent home purchase; early bird (only in eligible states where this discount is available); Homeowner's Association; fire extinguisher; deadbolt; paperless; notion promotion; and storm shutters if the property is in a High Velocity Hurricane Zone (HVHZ) and Wind Borne Debris region (WBDR).

Coverage A values may be mapped into Verisk when the system needs to calculate Coverage. For example, the following mapping may be used:
Map FirePlaces number to “Fireplaces”, use “Masonry fireplace” and the number of fireplaces;
NumberOfBedrooms map to the Verisk number of Bedrooms field;
NumberOfBathrooms maps to the Verisk number of Bathrooms field;
FoundationType maps to the Verisk Foundation Type field;
GarageType maps to the Verisk Garage/Carport style field; and
GarageSize maps to the Verisk values: Verisk field name—Garage/Carport; if detached, then maps under detached structures to detached garages of a specified size.

Following completion of the bulk quote process by the quote production database 406, an email is sent to the user that ran the quote, notifying the user that the process has completed. The communities and models may appear in the builder's producer portal, while the quoted communities may show up in the results section in a bulk quote portal within the dashboard 624 in the lead API 410.

If coverage A and/or other deductibles and/or coverage amounts are enforced for a community, they may be enforced as much as possible by the available insurance carrier's available coverage and lead API 410. However, if coverage A and/or other deductibles and/or coverage amounts are not enforced for a community, the coverage A for the available insurance carrier and/or deductibles for other insurance carriers will be enforced as much as possible by the available carrier's coverage and API (in order to try to create an “apples to apples” comparison).

### Process for Auto Assignment of Communities to Insurance Carriers

Once a file has been successfully processed in the quote portal (hence, at least one model was quoted), each model in the result file (hence the file that includes community and model name and relevant quotes) will be automatically assigned to a carrier based on the returned quotes. If a model already exists in the system and was already assigned to a carrier prior to running the file in question, that model will be handled based on the results obtained after running the new file. If the new results file includes the same carrier that is already assigned to the model, and the new quote in the file is equal or lower than the current quote, the current assignment is maintained and the quote is updated so that future quotes that will be sent to customers can use the new rate. On the other hand, if the new file includes the same carrier that is already assigned to the model, but the new quote is higher than the current quote, or if the carrier that is currently assigned to the community is not included in the new file (because the model in question cannot be quoted by this carrier at the moment), those models are treated as unassigned models and are assigned to a carrier based on an assignment algorithm.

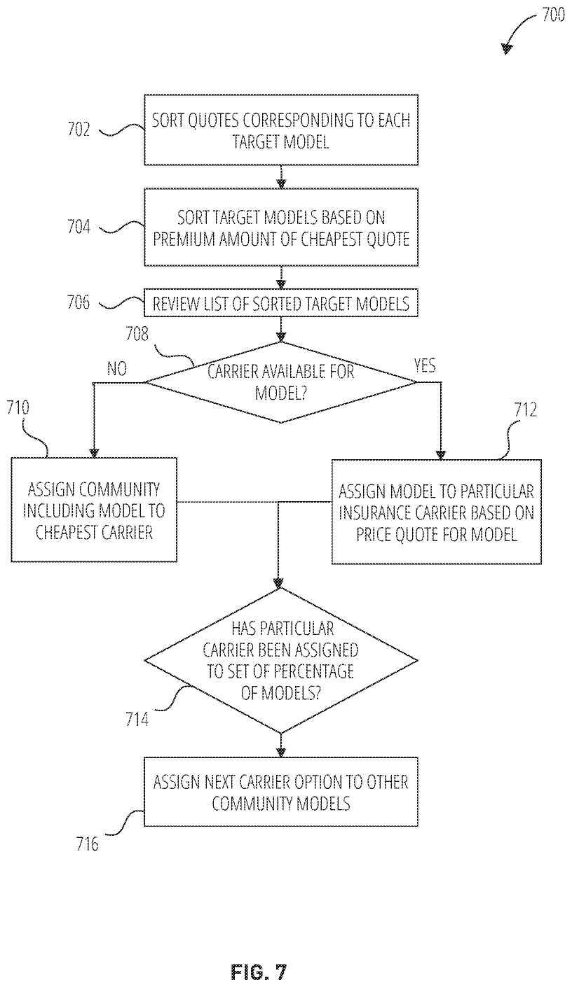

In sample embodiments, the assignment algorithm is run for unassigned models or models where their quote went up or their carrier is no longer available. Also, as will be described below, the assignment algorithm may be used to limit acquisition of risk by a particular insurance carrier by setting limits on the number of policies that a carrier may underwrite in a given community. A sample assignment algorithm is illustrated in FIG. 7.

FIG. 7 is a flow diagram illustrating a sample assignment algorithm 700 in accordance with one example embodiment. As illustrated in FIG. 7, for each of the target models under each one of the listed communities, the quotes are sorted corresponding to each target model at block 702. For example, the quotes may be sorted from cheapest to most expensive. All target models may be sorted based on the premium amount of their cheapest quote at block 704. For example, if (model, quote1, quote2, quote3) is the model name and the corresponding quote, then consider the following group:

(X, 500, 400, 1000), (Y, 1200, 800, 300), (Z, 600, 500, 1200)

and then sort for each model the quotes:

(X, 400, 500, 1000), (Y, 300, 800, 1200), (Z, 500, 600, 1200)

The assignment algorithm then sorts based on the cheapest quote for each model:

(Z, 500, 600, 1200), (X, 400, 500, 1000), (Y, 300, 800, 1200)

The sample assignment algorithm 700 then reviews the list of the sorted target models at block 706, starting with the target models that have the most expensive cheapest quote. At decision block 708, it is determined if a particular insurance carrier is available for a model. If the particular insurance carrier is not available for a model, or if the particular insurance carrier is more expensive by the predetermined percentage or more compared to the next cheapest option for this model, the community including the model is assigned to the cheapest carrier at block 710. On the other hand, for every target model where a particular insurance carrier is the cheapest option, OR if the particular insurance carrier is expensive by no more than a predetermined percentage compared to the next cheapest option for this model, this model is assigned to the particular insurance carrier at block 712. Once it is determined at decision block 714 that the particular insurance carrier has been assigned to a set percentage or more of the community models, then the assignment algorithm stops assigning the particular insurance carrier to the models in that community (even if the particular insurance carrier is the only option) and assigns the next option to other community models at block 716. However, if the particular insurance carrier has not been assigned to a set percentage or more of the community models, the particular insurance carrier may continue to be assigned to models in other communities.

If no quote is available, the model is not assigned. This approach assures diversity of insurance carriers in a particular community so that one insurance carrier would not be overly susceptible to a localized disaster such as a wildfire or localized weather event.

Models that have not been assigned to any carrier are considered “Orphan Models.” Once the assignment algorithm has been run, the user that triggered the run of the algorithm may be sent an email with the list of orphan models.

### Communities Review

A review is used to both review the results of a community bulk quote, as well as to review existing communities that were previously quoted. The results of the review may be used to change the assignment of carriers to specific models. The review includes filtering the results. For example, the filtering may include:

Searching by Division: A typeahead with dropdown based on existing divisions in the system is provided for division searching.

Search by geography: A zip code or state and/or city search.

Search by Community name and/or model name: free text—typeahead with dropdown based on existing communities and models in the system.

Search by Insurance Carrier name: free text—typeahead with dropdown based on current carriers in the system, including ones that were added manually, showing the communities where the carrier selected is assigned to a model in a community.

Search by Agent name: just like in the afore-mentioned leads page.

“Unassigned only”—checkbox (unchecked by default), if checked—will only show communities that include a model that was not assigned to any carrier.

For each community, information is retained in a table including, for example:

Community name

Community Address

Type—HO-3, HO-6 or HO-3+HO-6

Percentage of models assigned to a particular carrier

Percentage of models assigned to the particular carrier which is the most popular in this community (based on number of models assigned for the time being).

When the community is expanded, the table may be expanded to include, for example:

Model: including the model name, number of bedrooms, bathrooms and square footage, whether the model has a pool, and whether model is an HO-3 or HO-6 type. The stored data for the Model may also include the agent name that is assigned to the model based on a division based configuration file. An insurance carrier may be manually added to this model;

Assignment: whether model is assigned to an insurance carrier or not;

Carrier: the carrier's name;

Premium;

Deductible(s);

Cov A;

Cov C;

Expand CTA to see Cov B, D, E, F and additional fields including, for example:

For California (HO-3/HO-5/HO-6) include “Earthquake” (Yes/No) field;

For Florida (HO-3/HO-5) only, include:

Sinkhole Coverage (Yes/No) field;

Screened Enclosure Coverage (USD amount);

Catastrophic Ground Collapse (Yes/No) field;

For Florida (HO-6+HO-3/HO-5) include:

Replacement Cost on Contents Coverage (Yes/No) field;

Loss Assessment Coverage (Yes/No) field;

Limited Animal Liability (USD amount); and

Water Backup Coverage (USD amount).

The Cov A/general deductible for an insurance carrier may be modified by enabling a user to edit the coverage A amount and general deductible for an existing carrier (even if the carrier was not manually added). The user can view the square footage of the model that is being updated and, for guidance, when editing the coverage A, the user may be shown the rebuilding cost per square foot in each of the other models under the same community as well as the average cost per square foot across those models. Before saving the change, the user may be asked to confirm. Also, when saving the change, a requote with the insurance carrier may be retriggered, as described below.

Manually adding an insurance carrier for a builder may include, for example, a user manually adding a carrier (and a quote) to a given model. When manually adding a carrier (or editing one that was added manually), the coverage fields may be expanded so that all coverages will show coverage A to F. The required information for each carrier may include, for example:

Carrier name

Premium

Deductible(s)—general deductible is required, wind and hurricane are optional

CovA—F

Free text for notes, etc.

Additional fields including, for example:

For California (HO-3/HO-5/HO-6)—“Earthquake” (Yes/No) field;

For Florida (HO-3/HO-5 only):

Sinkhole Coverage (Yes/No) field;

Screened Enclosure Coverage (USD amount)

Catastrophic Ground Collapse (Yes/No) field

For Florida (HO-6+HO-3/HO-5:

Replacement Cost on Contents Coverage (Yes/No) field;

Loss Assessment Coverage (Yes/No) field;

Limited Animal Liability (USD amount);

Water Backup Coverage (USD amount).

There need not be any limitation on how many carriers can be manually added to a given model.

If a carrier was manually entered for a given model, the added carrier need not be automatically shown for another model. In other words, a manually added carrier is relevant only to the model for which it was added. Manually added carriers may be highlighted differently and can be edited or removed by the user (allow removing only if the insurance carrier is currently not assigned to the model). Editing any of the fields of the manually added insurance carrier may trigger a confirmation dialogue and send an email to the affected leads (leads assigned to that carrier that have an effective date of over 30 days from the date of change), as follows:

H1: “Confirm change and notify existing leads?”

H2: “By sending email notifications, all [model name] leads that are assigned to [carrier name] with an effective date of over 30 days from today will receive an email about their updated quote”

CTA—“Save and notify”, “Save—don't notify”, “Cancel”

To change the assignment to an insurance carrier, the agent user can change the assignment of a specific model to a different insurance carrier, either one of the list of existing carriers who returned a quote to this model, or to an insurance carrier that was added manually. Only one carrier can be assigned per policy, but a model can have no carrier assigned to it.

Once the user has confirmed the change of assignment, the system may ask for confirmation and whether existing leads should be notified about the new quote (leads that are assigned to the insurance carrier and have an effective date of over 30 days from the date of change). In such case, the following confirmation is requested:

H1: “Confirm change and notify existing leads?”

H2: “By sending email notifications, all [model name] leads that are assigned to [previous carrier name] with an effective date of over 30 days from today will receive an email about their new quote with [new carrier name]”

CTA—“Save and notify”, “Save—don't notify”, “Cancel”

In sample embodiments, a user can force a re-quote with the insurance carrier for a specific model if an online integration with that insurance carrier (API/XML) is available. A requote can either be initiated manually by the user (agent) or automatically triggered following a Cov A amount change by an agent. If the requote was manually triggered, a confirmation with the user is requested, as follows:

H1: “Are you sure you want to requote [model name] with [carrier name]?”

CTAs: “Yes”, “Cancel”

While requoting and when the results are returned, a comparison between the previous quote and the new quote is shown side by side with the following fields, for example:

Premium

Deductible(s)

Cov A

Cov C

A field allowing user to expand and see coverages B, D, E, F

For California and Florida, allow to the following additional fields to be shown:

For California (HO-3/HO-5/HO-6)—“Earthquake” (Yes/No) field;

For Florida (HO-3/HO-5) only:

Sinkhole Coverage (Yes/No) field;

Screened Enclosure Coverage (USD amount);

Catastrophic Ground Collapse (Yes/No) field.

For Florida (HO-6+HO-3/HO-5):

Replacement Cost on Contents Coverage (Yes/No) field;

Loss Assessment Coverage (Yes/No) field;

Limited Animal Liability (USD amount);

Water Backup Coverage (USD amount).

At this point, the new quote has to be accepted by the user, but the agent may be asked whether to notify all pending leads (that are assigned to that insurance carrier and have an effective date of 30 days into the future) about the new premium with the following options, for example:

H1: “Notify existing leads?”

H2: “By sending email notifications, all [model name] leads that are assigned to [carrier name that was requoted] with an effective date of over 30 days from today will receive an email about their new quote”

CTA—“Notify”, “Don't notify”

### Bulk Requote

A bulk requote option allows user to re-quote all models that have a quote with a certain insurance carrier in a selected state by asking for the following information, by way of example:

State—how only states where there is at least one community;

Insurance Carrier—show only carriers that have at least one quote in the selected state;

Once selection of state and carrier has been made, the user is asked if the user wants to proceed:

H1: “Please confirm re-quoting [carrier name] quotes in [state]”

CTA: “Continue”, “Cancel”

If the user confirms, continue to re-quote all the models in the state, where the insurance carrier already has a quote. The bulk requote may be logged in the history log of the model(s) as any other requote activity. In sample embodiments, the bulk re-quote process need not trigger an automated change of insurance carrier assignment, even if the new rates returned by the insurance carrier are not the most competitive.

To summarize, the models (grouped by community) are listed where a re-quote was made (even if there was no change). The before and after is shown for at least the following:

Premium

Deductible(s)

Cov A

Cov C

User can expand to see Cov B, D, E, F as well as the additional coverages for California and Florida.

At this point, the new quote has to be accepted by the user, but the agent may be asked whether to notify all pending leads (that are assigned to re-quoted carriers and have an effective date of over 30 days into the future) about the new premium:

H1: “Notify existing leads?”

H2: “By sending email notifications, [number of leads that their quote has changed as a result of the requote] leads that are assigned to [carrier name that was requoted] and have an effective date of over 30 days from today will receive an email about their new quote”

CTA—“Notify”, “Don't notify”

### Model History Information

For each model, the system may show the model information history and the insurance carriers over time. For example, the following fields of historical records may be maintained for each model:

Assigned insurance carrier change

Coverage A change for each insurance carrier that has a quote for the model

Requote of an insurance carrier for the model

Insurance carrier was manually added under the model

Insurance carrier was edited

Insurance carrier was removed

Model information changed including fields such as: model name, policy type, square footage, sales price, number of bedrooms, number of bathrooms, number of stories, garage size, garage type, and presence of storm shutters.

For all changes listed above, the following information may also be included:

Date+time of change

Name of agent who did the change

Change itself and, if applicable, the original value pre-change

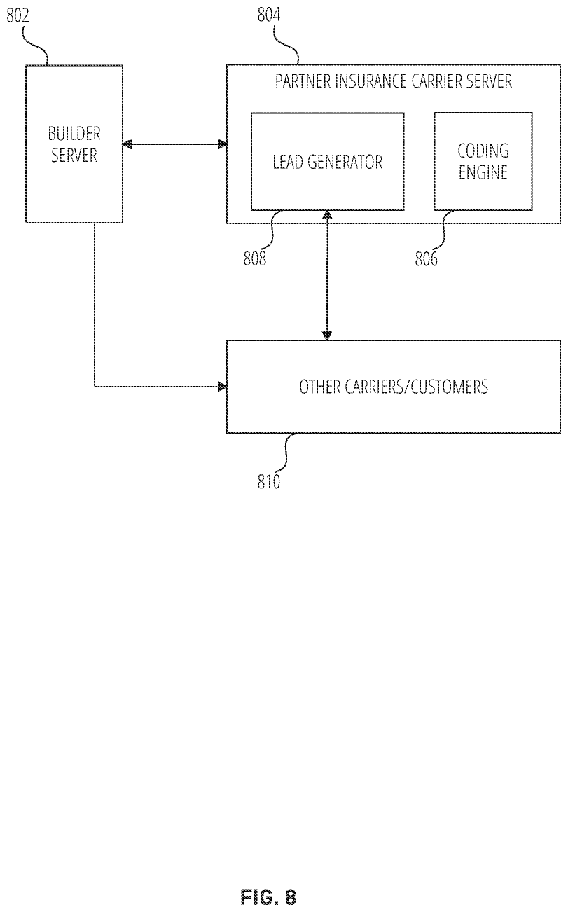

FIG. 8 is a block diagram illustrating communication of the builder server with the server of a partner insurance carrier to provide housing data for use by the server to generate codes for each housing product using a coding engine in accordance with one example embodiment. In sample embodiments, the data fed from partners for use in insurance quotes also may be used to map leads according to specific codes provided within a lead generation model. As illustrated in FIG. 8, the builder server 802 communicates with the partner insurance carrier server 804 of a partner insurance carrier to provide housing data for use by the partner insurance carrier server 804 to generate codes for each housing product using coding engine 806. In turn, the generated codes are provided to a lead generator 808 that generates and manages sales leads for purchasing insurance for each home model. The coded leads may be shared with other carriers/customers 810 to enable faster closing of the sales in response to the coded leads. In the example where the partner of the insurance carrier is a home builder and the customer is a home purchaser, the coded leads may be generated for the new homes being built by the home builder using home data provided by the home builder from the builder database 402 and customer data provided by the customer and/or the home builder. The captured data is integrated into the builder database 402 and used by the partner insurance carrier to underwrite insurance policies and to generate insurance quotes from the partner insurance carrier and/or from other carriers/customers 810 that are available to service the homes in the geographic area of the new homes. The insurance leads based on the quotes are generated by a lead generation model of the lead generator 808, assigned to one or more other carriers/customers 810, and managed by the lead generator 808. As noted below, the lead generator 808 may use risk management considerations (for example, assigning no more than a fixed percentage of homes in a development to a particular carrier) to verify that no one insurance carrier is overexposed to claims risk in a given geographic area.

The insurance quotes may be selected to provide the most value for the builder and/or the customer for a particular home model. The codes generated by the coding engine 806 may be used to match the models to insurance quotes and to fine tune the quotes as data is modified by the builder and/or the customer, while the lead generator 808 may be used to match the generated sales leads to the customers for the respective homes. The resulting process generates leads much faster as the housing data is pre-captured from the builder and enough data about the customer is available from the builder to generate quotes for consideration by the customer at or before the time the home is purchased. For example, the model and community for the home may be looked up in the builder database 402 to provide all relevant data for the insurance quote and processed by the partner insurance carrier server 804 as a batch in a bulk quote processing system. In this manner, homes may be coded for insurance quotes even before they have been built.

The partner insurance carrier server 804 may further execute instructions to implement rules that are executed by one or more Processors to implement the lead API 410 that recognizes a lack of inputs for a quote, predicts values for the missing inputs using data from a builder and artificial intelligence that may recognize data trends to generate the missing data. The generated data may be provided in the builder database 402 until replaced by actual data provided by the builder and/or the customer through the lead API 410. In sample embodiments, a real-time integration data feed from a partner such as a builder may be used by an artificial intelligence system within the partner insurance carrier server 804 to map data to/from the partner.

An integrated data feed from the partner to the partner insurance carrier server 804 may provide builder data to an application programming interface of the builder that is integrated with insurance data from a provider and user data from a customer. The integrated data may be parsed, validated, and converted to a common data format use by the production system 408 to create quote requests from one or more insurance carriers that service the geographic area. The quotes from the insurance carriers may be generated automatically or may be generated manually using manual inputs from insurance agents. The resulting quotes include unique codes from the insurance carriers that are recognized by a quote policy engine of the partner insurance carrier server 804. The received codes are sorted and assigned to the various home models of the builder.

One or more codes may be assigned for each home model as a function of price and features and shared with the builder. The quote options for a given model may be presented to the customer for selection at or before the time of the home purchase. The customer's selection may then be used by lead generator 520 to generate a lead that is provided to the corresponding insurance carrier and managed by the carrier's lead management system. Conversely, the codes from the insurance carriers may be assigned to the customers and/or the customers may be assigned to the insurance carriers based on a distribution algorithm that minimizes the risk to a particular insurance carrier. For example, it may be desirable to limit the exposure of a particular insurance carrier in a geographic area to minimize the liability exposure of that particular carrier in the event of a natural disaster such as a fire or flood. The codes may correspond to monthly and annual premium rates as well coverage limits and deductibles.

### Leads Management Portal

The system described herein may also include a leads management portal that enables a user to review existing leads. In particular, the leads management portal allows a user (e.g., an insurance agent) to review, filter, and download the leads and policies that are currently in the system. Filters may be provided that enable the user to perform a universal search for the following fields:

1. Reference Number

2. Address

3. Name

4. Loan Number

5. Policy Number

6. Email address

The user may be enabled to filter by division and status of leads and/or policies. For example, the listed status of leads may include icons representing default, pending consent, consented, consented—quote changed, no quote, exception, bound, or canceled.

The system may also filter by estimated closing date by, for example, providing a dropdown menu with prefilled options like future 7 days, 30 days, and 60 days, and enable the user to select the date range. Similarly, the system may filter by effective date (date range dialogue, leads+policies). The user may also be given the ability to filter leads by exception and to select leads with a specific exception.

Once the filters are expanded, the following information may be displayed:
Community and model name (typeahead, filter by the list of communities and models that exist in the system for a particular home builder, leads+policies);
Agent;
State;
Insurance carriers for which at least one lead was assigned to, leads+policies);
Leads versus policies;
Hidden versus not hidden; and
Whether customer has been contacted (Yes/No, will filter based on whether the lead was sent an email for leads only; will be disabled once policies only is selected).

The leads may be displayed in a table that is sorted by estimated closing data in ascending order. The table may also include columns specifying, for example, the reference number. The reference number represents the lead identification in the builder system, regardless of the insurance carrier and regardless of whether the lead is still a lead or a policy. The agents use this number to communicate with each other on a specific lead. The reference number may be in a running order and should be available on a lead even if the quote is missing. Other columns in the lead table may include: lead status, buyer name, effective policy date, closing date, community name, model name, and property address.

The lead table may also include lead exceptions such as:
“Lead already exists”—when a lead which is 30 days or less exists in the system;
“Old lead was rewritten”—when an existing lead was 30 days or more and it was rewritten in the system;
“Community not found”—when there was no community found in the database based on the purchased property state (can be resolved either by uploading a new community and model to the system and then assigning the lead to this new model via the “Additional information” or by assigning the lead to an existing community and model via the “Additional information” dialogue);
“Model not found”—when community was found in the relevant state but the model was not found (can be resolved either by uploading a new model to system and then assigning the lead to this new model via the “Additional information” or by assigning the lead to an existing model via the “Additional information” dialogue);
“Model is missing quote”—the community/model pair was found in the system, but the model is not assigned to an insurance carrier (can be resolved by adding a carrier to the model and then assigning the lead to this carrier);
“No email on Lead”—the lead does not have an email on file; and
“Unable to bind”—the lead has consented but is unable to bind due to a technical reason.

As exception may also be based on whether an email has been sent to the lead. If the lead can receive an email (hence the lead is assigned to a model and a carrier), including a CTA—“Send email” which will send the email again (leads only), this field may be used to enable the quote email to introduce the currently assigned carrier.

Additional fields may include the time a lead email has been sent, the lead's name (full name, lead+policies). When the object is a lead, it can be edited by the agent. When changed, the change is logged in the lead's history and the evidence of insurance (EOI) is recreated with the new name on file.

Still other fields may include the address of the quoted/insured property, including leads and policies, as well as the agent's name. The agent's name can be edited if the object is a lead. An initial quote date can be used for sorting when clicked on, and an effective date for leads and policies can be used for sorting when clicked on. Similarly, the closing date for leads and policies can be used for sorting when clicked on.

A status field (leads+policies) may include one or more of the following status indicators:
Lead
Lead—pending rate change, if a lead was requoted and did not accept a new rate yet
Policy (used if an integration with the carrier is not available so the specific policy status cannot be determined)
Policy—Pending Active
Policy—Active
Policy—Pending non-Renewal
Policy—Pending Cancellation
Policy—Terminated
Policy—Expired

An additional information field relating to leads and policies may open a portal showing the information collected from the lead in the application flow as well as any additional information such as:

Contact information (editable for both leads and policies), including email, phone number, and mailing address.

Opted in—Yes or No. The initial value is set based on the lead's input file. Can be edited and will be logged in the history log. If set to “No”, then the sending of quote emails to the customer from the system will be blocked (e.g., send email button is disabled and changes to quote will not trigger any automated email).

Community name can be edited if the object is a lead (read only if object is a policy). If the community name is changed, the model name field is cleared which needs to be selected as well.

Model name can be edited if the object is a lead but is read only in case it is a policy (and such changes will be logged in the lead history). If the model has changed, the lead is assigned to a new carrier based on the assignment of the new selected model. The agent is asked if she wants to send a quote email to the lead and the other parties about the new quote. If the change was confirmed, a quote is obtained for this lead from the new insurance carrier.

Quote ID (if the object is a lead) is provided by the insurance carrier and may be provided manually if an insurance carrier has no XML/API integration.

Policy number (if the object is a policy) is provided by the insurance carrier.

User provided data from the application flow including, for example, data points that the user changed, which will be highlighted differently to indicate that the user changed them. If the object is a lead, then the data points can be edited by the agent, which will be logged in the history archive for this lead. If the lead is associated with an insurance carrier that has an API/XML integration, then changing of those fields will result in a requote. If the object is a policy, the data points are read only.

Lead creation information includes the file name from where the lead was created, including date and time of creation. If the lead was not created from a file (e.g. agent used a producer flow to create a lead that did not appear in the file), show “Lead created by flow” instead of the lead file.

Notes History—The Leads Details Page may have Notes History. An agent may have the ability to create a note. The notes are sorted by timestamp and may also have the name of the agent that created the note. Once a note is created it cannot be edited or deleted. The notes should appear in reverse chronological order.

Allow adding spouses and additional insured (leads only). For each of the following add first name, last name, email address (optionally). If the email address was provided, send an email to the added person, introducing the quote and notifying them they were added to the quote.

The lead information entry in the table will be highlighted differently if the lead made some changes in the information when they went through the application flow.

### Lead History (Leads Plus Policies)

An agent needs to have a holistic view on the lead and what updates were made upon it during its lifecycle to help the agent close the lead. The Leads History helps with account management on a lead by tracking what updates were made to the lead by external sources and system events. The lead history also provides support documentation in the event of an errors and omissions claim. The Leads History also should track any updates made to the lead through a leads file of the builder, the insurance agent, or the end user.

In sample embodiments, the system allows the agent to review past changes made in the lead, either by an agent, by a lead, or by lead file ingestion. In the sample embodiments, the system displays the following information for each of the fields that are included in a lead/policy history:

Date and time of change;

Who made change;

Show “Lead initiated” if change was made by the lead during the consent flow;

Show “System initiated” if lead updated by internal automated process;

Field changed—considers all the questions asked in the application flow (including the free text field) and all values that can change in the leads table (including insurance carrier name, premium, deductible(s), coverages, lead name).

The value is shown before the change as well as the value after the change. If the user entered information for the first time in the open text field, it will not be considered a change that will be logged in the lead history section. However, if the user enters the text again, then the new text will be shown and compared to what was entered before. If there are any changes made to the lead from lead file upload, they would be captured as well. Changes by a requote on a lead as well as changes to the lead's coverage, deductible and premium (either as a result of a requote or manual editing) also may be shown. Lead status updates, including date, time, and source of update may also be shown, as well as emails sent to the lead by date and time sent, subject line, who email was sent to, and who triggered email. Finally, the date and time that the customer accepted the consent flow may also be shown.

Other fields include whether the lead agreed to bind, which is based on whether the lead completed the application flow and provided permission to bind the policy. A coverage details field can collapse and expand those fields as needed for leads and policies. The coverage details may include the insurance carrier name that the lead is currently assigned to. If an object is a lead, then this field can be edited (but read only if object is a policy). The user can select a different carrier based on the customer's request. Once a new insurance carrier is selected, coverage, premium and deductible amounts will all be updated based on the coverage details of the newly selected carrier. On the other hand, once a carrier selection has changed, it triggers an entry in the history log and will issue a quote from the insurance carrier. The lender will be updated, and the customer will receive the insurance carrier email and an agency email.

As noted above, additional standard fields include premium in USD, deductible(s), and coverages. Coverages A and C may be shown by default, but the user can expand to also show coverages B, D, E, F as well as the additional coverages for Florida and California. The user also can edit the deductible(s) and coverages A-F as well as premium field (if the insurance carrier is not integrated via API/XML).

A requote interface may also be provided as part of the coverage details since once an agent changed a coverage amount, a requote has to be triggered. The system may force the lead to be requoted by the current insurance carrier, which is often used when an insurance carrier has a rate change or when some information changed (e.g. when the agent edited coverage fields). The requote functionality is enabled only if the object is still a lead (not a policy) and the assigned carrier has an XML/API integration with the system. In sample embodiments, the CTA includes “Requote,” which will trigger the requote process by calling the insurance carrier. The user will be asked to confirm the action before requoting. On the other hand, if there were no changes to any field (coverages or deductibles), a “Close” button will close the lead view and will return the user to the leads table. If there was a change to any field, and the user did not requote with the most recent changes, the following interaction will be shown:

H1: “Unquoted changes exist. Requote lead?”;

CTA 1—“Requote”—will trigger a requote;

CTA 2—“Close & dismiss changes”—will close the lead coverages page with dismissing the changed values. Coverage/Deductible values will be restored to the last quoted state (either based on the most recent requote or the initial quote if no requote was done); and

CTA 3—“Cancel”—will get back to the lead coverage page without making any changes to the values (essentially as if the user did not click on the “Close” button to begin with).

Following the requote, the agent will see the new results compared to the old results, including premium, deductible(s), and coverages (A-F). The user will be asked whether to send an email to the lead that has been requoted. If the agent selected to send an email, the lead will get the email introducing the new quote following a requote, but the link in the email will take the lead to a regular consent flow if the customer did not give a consent to bind before. Alternatively, the lead may be taken to a “mini” consent flow, listing the new quote and coverage, if the customer did give a consent to bind already.

### Manually Creating a Lead

An agent can also manually add a lead to the system, in case a lead calls in asking for a quote. If the lead is interested in a quote to a model that was assigned to a designated insurance carrier, then the easiest way to create a lead is to go into the builder portion of a producer portal to get a quote, which will also create a lead in the system. However, if the lead is not quoting a community assigned to the particular insurance company, then a lead entry is created in the system that the agent can then use to quote on the third party site. Like a manually added carrier, a manually added lead can be removed and edited. Also, the following fields may also be collected as part of manually adding a lead:
Community and model
First and last name
Middle name (optional)
Contact information (email, phone number, and/or mailing address)
Property address
Agent
Status (from the list of statuses defined above). When adding Manually, the lead status should be pre-selected to be default.
Initial quote date
Estimated Closing date (optional)
Additional insured (optional)
Insurance carrier
Quote ID (optional)—shown if selected insurance carrier does not support XML/API integration.
Policy number

Coverage details (deductible, coverages A-F and premium) will be populated as read only based on the default values of the selected insurance carrier for the lead's model. In order to change those, the lead needs to be saved first, and then requoted with the new coverage values.

When the agent clicks on a lead, if the lead is assigned to the designated insurance carrier, take the agent to the HO-5 producer flow for this specific flow. On the other hand, if the lead is lead for a different insurance carrier, a modal may be presented that includes the following information:
H1: “Complete purchase”
Body: “To complete the purchase of the policy, please go to [link to the insurance carrier's website, which when clicked will open in a new tab]”

If the customer did not give permission to bind, show the following message: “Customer did not provide consent to bind yet, please make sure to secure one before binding”

Include the following question and input fields:
Policy sold? (Y/N)
Additional fields to collect once toggled to “Yes”:
   Policy number
   Effective date
   Premium
   Deductible(s)
   Coverage(s)

Once toggled to “Yes” and information was provided, the lead will change the status into a policy. This designation can be reversed and toggled back to “No” which will result in the customer becoming a lead again. The additional information may be saved, so if the user reverted back to “Yes,” all the additional fields will be available.

The workflow for the agent may include uploading the policy documents pertinent to a policy. When a document is uploaded, the timestamp of the document upload and the user that uploaded the document may be captured. PDF and JPEG file types may be supported for the document upload. There is no validation that the uploaded document matches the document type. The list of documents may include. For example:
Errors and Omissions Insurance (EOI)
Other Policies
Replacement Cost Estimate
Appraisals
Burglar Alarm Certificate
Cancellation Request
Company Memo
Other Quotes
Letter to Customer
Letter from Customer
Photos
Miscellaneous

The workflow for the agent may also include download, which downloads the selected leads/policies and the different columns into a comma separated values (CSV) file including the community name and model name.

During the upload of a file, the user may be asked to upload a file which contains at least the following fields:
Job number (unique identifier for the lead, even if name/address changed)
Buyer full name (split into first middle last)
Buyer phone number
Buyer email address
Second buyer full name (split into first middle last)—optional
Second buyer phone number—optional
Second buyer email—optional
Third buyer full name (split into first middle last)—optional
Third buyer phone number—optional
Third buyer email—optional
Fourth buyer full name (split into first middle last)—optional
Fourth buyer phone number—optional
Fourth buyer email—optional
Current mailing address—if available
Address of property purchased
Expected closing date—if available
Community+model (each one in a separate field) based on community and model numbers that showed up in the community/models file
Options purchased for the property (e.g. extra bedroom)—if available
Loan information that enables prefilling the checkout page—if available (loan number, lender name, lender address, loan officer name and contact information)
Loan Processor email address to enable sending back the EOI—if available
Occupancy (owner occupied Primary/Secondary or Rental/Investment)

### Matching Leads to Insurance Carrier's Process

The community name and the model name in the lead file are matched with the community name and model name fields in the community+quotes database. For the matched model, the following fields of the insurance carrier which is assigned to this model is obtained: insurance carrier name, annual premium, coverages A-F, and deductible(s). A match against existing leads that are already in the system is provided based on the “Job number” field. For every customer entry in the file where a result was returned, and no lead existed in the system (see exceptions below), a lead is created with a quote in the system of a designated insurance carrier. The lead will appear in the organization's builder portal as well.

Existing leads may be determined based on the Job number field. If there is a lead in the designated insurance carrier's system with the same email address and property address, then if a lead in the system is older than 30 days, treat this customer entry as a new lead (but include an exception note in the output file). On the other hand, if a lead in the system is 30 days old or less, do nothing but include an exception note in the output file as described below. Customers whose model was not found in the communities/models database may need to create a lead in the builder portal. In such a case, an exception note is included in the output file. Similarly, customers whose model was found but have no assigned carrier may need to create a lead in the builder portal and include an exception note in the output file.

### Matching Leads to Agents Process

Agents may be matched to a lead based on their division. For each lead where there is a community, the division code may be extracted from the community file (“Division Code” column) and the lead may be matched with the agent who is in charge of leads from that division.

### Matching Process Output

The results of the matching between leads and insurance quotes in the table may be displayed. The table may have the same fields and columns as in the leads view described above, but instead of the “email sent” it also may have a checkbox indicating whether an email should be sent to those leads. A “Send email” checkbox will be unchecked and disabled for the customer entries with the following exceptions: “Community not found;” “Model not found;” and “No insurance quote.” The “Send email” checkbox will be unchecked and but can be checked when the customer entry has the “Lead already exists” exception. Also, the “Send email” checkbox will be checked and can be unchecked like any other entry when the customer entry has the “Old lead was rewritten” exception.

CTA 1—Download output file may be required in order to deal with the exception (mostly community/model not found). The “Exception” column may have the values described above. The downloaded output file may further include all of the customer input file columns and the following assigned carrier columns: insurance carrier name, annual premium, coverages A-F (each one in a separate column), and deductible(s).

CTA 2—An email campaign will be triggered to all customers that their “Send email” checkbox was checked.

A user also can download previous output files (history).

### Risk Management

In sample embodiments, the lead generator may assign codes to properties and match the properties to insurance carriers to diversify claims risk within a community defined by a builder. For example, since a new community includes properties that are all in the same geographic area, the properties may all be susceptible to the same natural disaster (e.g., earthquake, flooding, fire, etc.), which would impose a significant claims risk on a particular carrier if that carrier were to insure a large portion of the properties in a particular community. For this reason, it is desirable that the builder partner with multiple insurance carriers to insure a particular community under development.

To limit risk, the properties and policies are coded and assigned to insurance carriers to diversify the risk profile for a new community. A threshold percentage is set for each community that is used to limit the percentage of overall policies and/or overall claims value that may be assigned to a particular insurance carrier. The insurance carriers would thus be limited to underwriting a number of policies that does not exceed the threshold. This threshold is imposed by the builder quoting service 110 described herein. The different carriers are preferably chosen from different geographic regions to limit liability. The rules for assigning the carriers to insurance leads may be dynamic and based on business considerations that may or may not be managed by state insurance regulatory bodies. Artificial intelligence driven predictive modeling may also be implemented to predict exposure in a geographic area of a community based on historical claims data and the like in order to set pricing as well as to set the threshold for the total number of properties and/or policy values that may be assigned to a particular insurance carrier.

The inputs into the algorithm for diversifying risk may include the plans of the respective properties, including square footage, type of home, volume of each type of home, local community geographic conditions (e.g., flood plain, pasture, etc.), home characteristics (e.g., roof type), all of which may be obtained from the builder server 404. Other information, such as fire and flood history for the geographic area, may be obtained from other vendors. In the absence of such data, defaults may be used for a given geographic area based on its geographic characteristics. Other data input into the algorithm for diversifying risk may include the prices of the home and property, weather data (e.g., wind and flood records), satellite data showing the roof of each home, etc. This data is processed by the algorithm to determine risk factors for the community to assign low, medium, or high risk values to the respective properties. For example, the risk evaluation may include location relative to natural events such as flood, wind, fire, etc., type of home and volume of homes of a particular type, and volume of homes underwritten in the community using historical data. Past claims incidents in the geographic area may be applied against the risk appetite and underwriting preferences of the carriers to determine which carriers are available and to what extent.

It will be appreciated that when the risk factors are applied to new homes under construction that different risk factors may apply. For example, the risk factors for the human occupants cannot be assessed prior to consideration of a particular homeowner. That information can be added once a sales lead has been generated.

In sample embodiments, the quoting service engine 126 tracks policy completion upon entry of policy details by an agent to track the exposure of a particular insurance carrier in the community. The exposure for each carrier may be compared to the established risk thresholds to establish whether the particular carrier has exceeded the allocated policy threshold. If so, the policy is reassigned to a new carrier, typically the carrier with the next best pricing. Thus, rather than regulating policy distribution by zip code, the builder data may be used to regulate the policy distribution within a particular community defined by the builder.

It will be appreciated that the data provided to the algorithm for diversifying risk may be provided in real-time and vary significantly over time. Also, the rules applied to the received data may be dynamic and incomplete. In sample embodiments, incomplete data may be completed with data that is specific to each community by pulling in data from the builder and/or analyzing available data to use predictive machine learning techniques to complete the missing data. By starting with the builder data for the home models including the location and plans, much of such data may be obtained from the builder files in order to create a full picture of a home for purposes of generating an insurance quote. A machine learning model may fine tune the data by evaluating the risk factors to evaluate their relevance for a particular community. For example, the roof shape, property location, and other factors may be a proxy for the aggregate risk. Similarly, the construction type and distance to a water source and average wind velocity may be a proxy for risk of flooding. The resulting values may be used to set the thresholds for managing the risk diversification as described above.

### Lead File Upload Report

Once a lead file upload is completed, the upload report may be sent to the agent summarizing the changes. The following is a sample of a lead file upload report.

| | | |
|---|---|---|
| Total of | <count> | |
| new leads | | |
| Total of | <count> | |
| canceled | | |
| leads | | |
| Total of | <count> | |
| changed | | |
| leads | | |
| Total leads | <Count | |
| that have a | of leads | |
| quote | uploaded | |
| assigned | with a | |
| | quote | |
| | assigned> | |
| Total leads | <count> | |
| with | | |
| exception | | |
| Leads that | <count> | <list |
| do not | | of |
| have a | | Ref |
| matching | | ID's> |
| model | | |
| Leads that | <count> | <list |
| do not | | of |
| have a | | Ref |
| community | | ID's> |
| Leads that | <count> | <list |
| have | | of |
| matched | | Ref |
| model but | | ID's> |
| missing a | | |
| quote | | |
| Leads that | <count> | <list |
| are | | of |
| missing an | | Ref |
| email | | ID's> |
| Leads that | <count> | <list |
| have a | | of |
| manual | | Ref |
| quote | | ID's> |
| assigned to | | |
| them | | |
| Leads that | <count> | <list |
| already | | of |
| have a | | Ref |
| policy and | | ID's> |
| in this file | | |

The disclosed systems and methods thus provide the practical application of generating codes that characterize homes and insurance policies so that the homes may be matched to insurance policies of a plurality of carriers in an apple to apple comparison. Also, by integrating the codes into the database of a builder of a new community, the policies may be offered at the time of sale of the homes, and sufficient policy risk diversification over multiple insurance carriers may be assured. These and other practical advantages will be apparent to those skilled in the art.

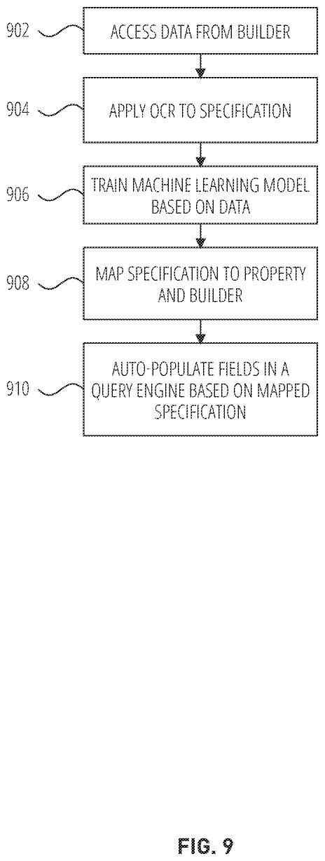

FIG. 9 is a flow diagram illustrating a method for auto-populating fields of a query engine in accordance with one example embodiment. The method may be performed by one or more computational devices, as described below. Operations in the method may be performed by the data augmentation application 122, using Components (e.g., modules, engines) described above with respect to FIG. 2. Accordingly, the method is described by way of example with reference to the data augmentation application 122. However, it shall be appreciated that at least some of the operations of the method may be deployed on various other hardware configurations or be performed by similar Components residing elsewhere. For example, some of the operations may be performed at the third-party server 112.

At block 902, the builder feed interface 202 accesses data from a builder.

At block 904, the builder OCR engine 208 applies OCR to specification data (e.g., text) from the builder.

In block 906, the builder machine learning engine 206 trains a machine learning model based on the data from builder feed interface 202.

In block 908, the builder mapping engine 210 maps specification data to a particular property and/or builder. In block 910, the builder mapping engine 210 auto-populate fields in a query engine based on mapped specification.

It is to be noted that other embodiments may use different sequencing, additional or fewer operations, and different nomenclature or terminology to accomplish similar functions. In some embodiments, various operations may be performed in parallel with other operations, either in a synchronous or asynchronous manner. The operations described herein were chosen to illustrate some principles of operations in a simplified form.

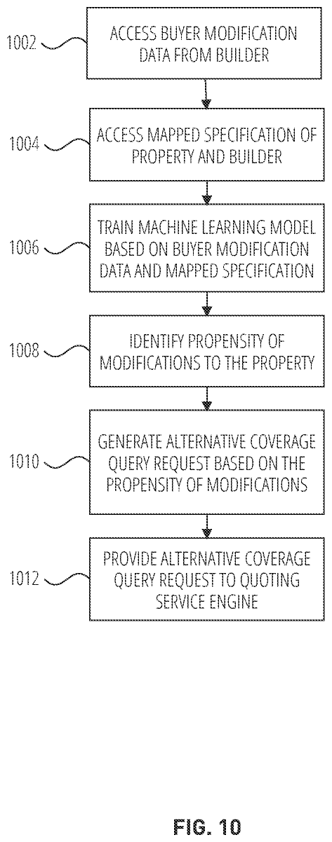

FIG. 10 is a flow diagram illustrating a method for generating alternative coverage queries in accordance with one example embodiment. The method may be performed by one or more computational devices, as described below. Operations in the method may be performed by the data augmentation application 122, using Components (e.g., modules, engines) described above with respect to FIG. 2. Accordingly, the method is described by way of example with reference to the data augmentation application 122. However, it shall be appreciated that at least some of the operations of the method may be deployed on various other hardware configurations or be performed by similar Components residing elsewhere. For example, some of the operations may be performed at the third-party server 112.

In block 1002, the builder feed interface 202 accesses buyer modification data from builder. In block 1004, the builder feed interface 202 accesses mapped specification of property and builder. In block 1006, the builder machine learning engine 206 trains a machine learning model based on buyer modification data and mapped specification. In block 1008, the builder machine learning engine 206 identifies propensity of modifications to the property. In block 1010, the builder mapping engine 210 generates alternative coverage query requests based on the propensity of modifications. In block 1012, the builder mapping engine 210 provides alternative coverage query requests to the quoting service engine 126.

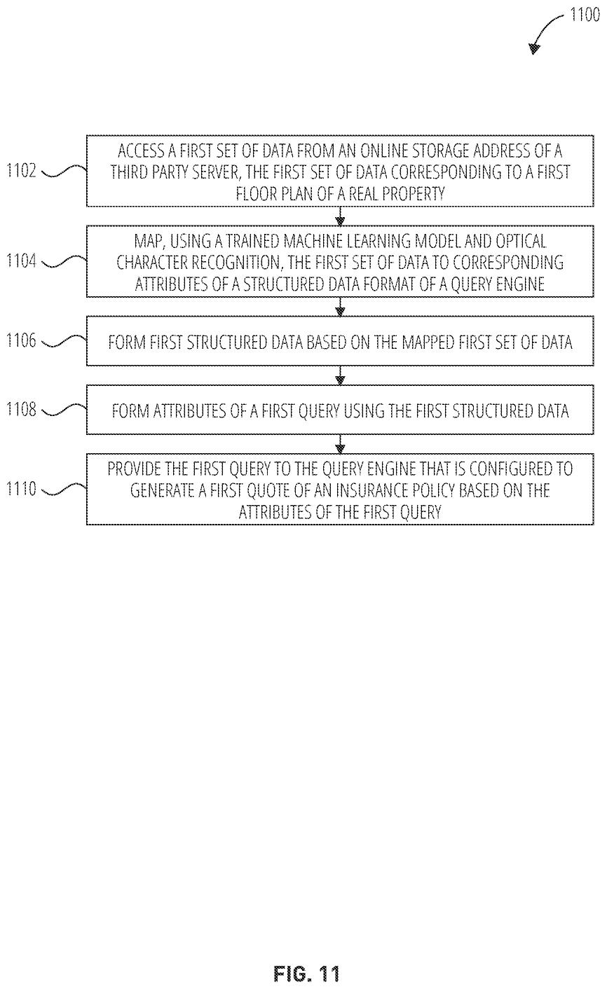

FIG. 11 illustrates a routine 1100 in accordance with one embodiment. In block 1102, routine 1100 accesses a first set of data from an online storage address of a third party server, the first set of data corresponding to a first floor plan of a real property. In block 1104, routine 1100 maps, using a trained machine learning model and optical character recognition, the first set of data to corresponding attributes of a structured data format of a query engine. In block 1106, routine 1100 forms first structured data based on the mapped first set of data. In block 1108, routine 1100 forms attributes of a first query using the first structured data. In block 1110, routine 1100 provides the first query to the query engine that is configured to generate a first quote of an insurance policy based on the attributes of the first query.

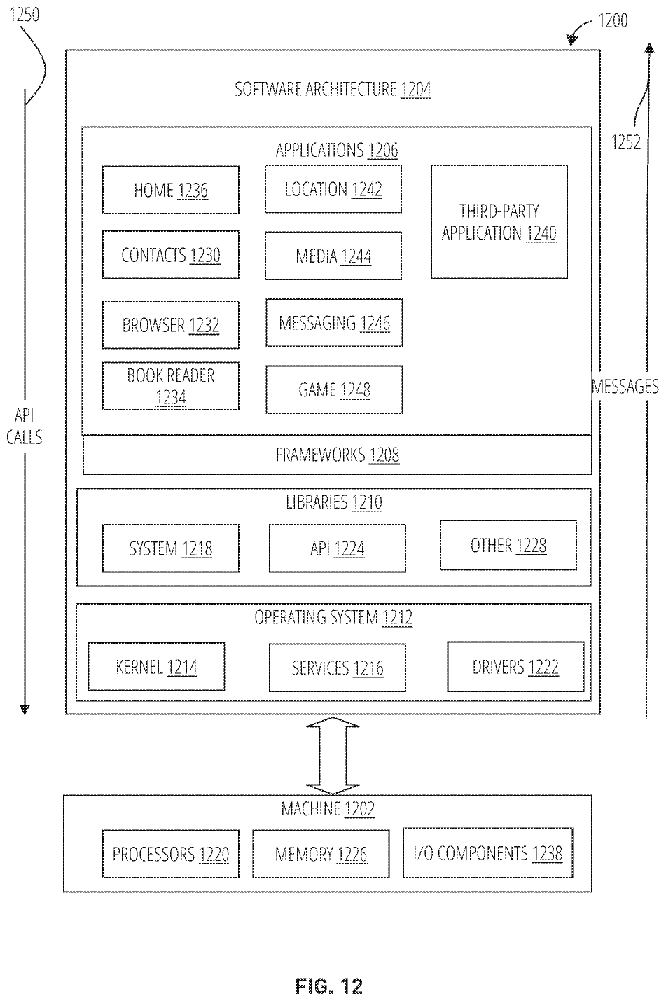

FIG. 12 is a block diagram 1200 illustrating a software architecture 1204, which can be installed on any one or more of the devices described herein. The software architecture 1204 is supported by hardware such as a machine 1202 that includes Processors 1220, memory 1226, and I/O Components 1238. In this example, the software architecture 1204 can be conceptualized as a stack of layers, where each layer provides a particular functionality. The software architecture 1204 includes layers such as an operating system 1212, libraries 1210, frameworks 1208, and applications 1206. Operationally, the applications 1206 invoke API calls 1250 through the software stack and receive messages 1252 in response to the API calls 1250.

The operating system 1212 manages hardware resources and provides common services. The operating system 1212 includes, for example, a kernel 1214, services 1216, and drivers 1222. The kernel 1214 acts as an abstraction layer between the hardware and the other software layers. For example, the kernel 1214 provides memory management. Processor management (e.g., scheduling), Component management, networking, and security settings, among other functionality. The services 1216 can provide other common services for the other software layers. The drivers 1222 are responsible for controlling or interfacing with the underlying hardware. For instance, the drivers 1222 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 1210 provide a low-level common infrastructure used by the applications 1206. The libraries 1210 can include system libraries 1218 (e.g., C standard library) that provide functions such as memory allocation functions, string manipulation functions, mathematic functions, and the like. In addition, the libraries 1210 can include API libraries 1224 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1210 can also include a wide variety of other libraries 1228 to provide many other APIs to the applications 1206.

The frameworks 1208 provide a high-level common infrastructure that is used by the applications 1206. For example, the frameworks 1208 provide various graphical user interface (GUI) functions, high-level resource management, and high-level location services. The frameworks 1208 can provide a broad spectrum of other APIs that can be used by the applications 1206, some of which may be specific to a particular operating system or platform.

In an example embodiment, the applications 1206 may include a home application 1236, a contacts application 1230, a browser application 1232, a book reader application 1234, a location application 1242, a media application 1244, a messaging application 1246, a game application 1248, and a broad assortment of other applications such as a third-party application 1240. The applications 1206 are programs that execute functions defined in the programs. Various programming languages can be employed to create one or more of the applications 1206, structured in a variety of manners, such as object-oriented programming languages (e.g., Objective-C, Java, or C++) or procedural programming languages (e.g., C or assembly language). In a specific example, the third-party application 1240 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1240 can invoke the API calls 1250 provided by the operating system 1212 to facilitate functionality described herein.

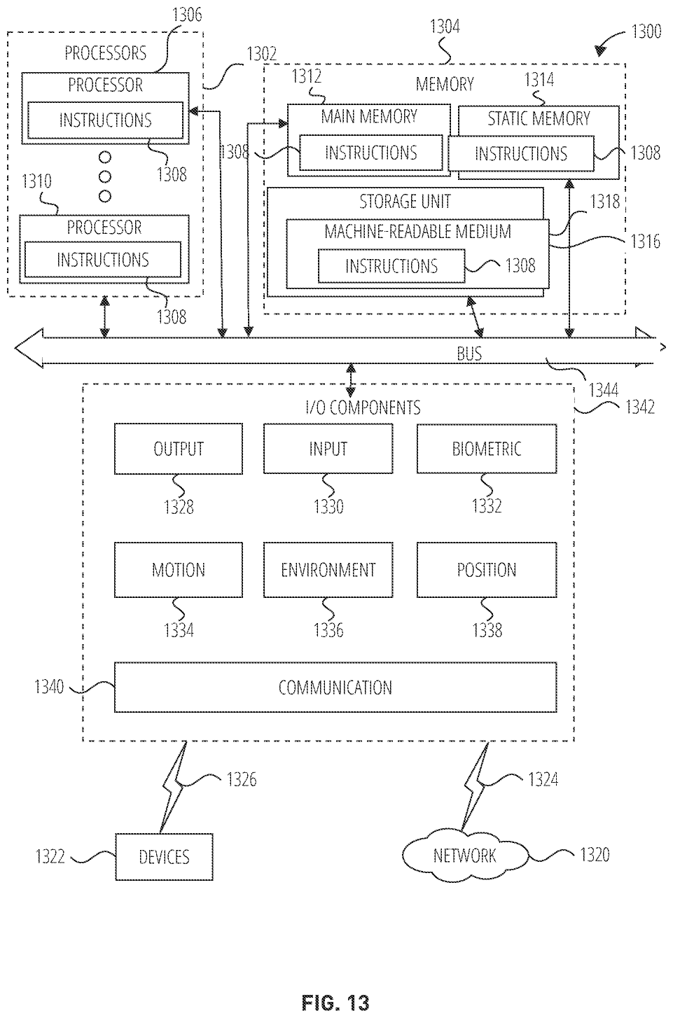

FIG. 13 is a diagrammatic representation of the machine 1300 within which instructions 1308 (e.g., software, a program, an application, an applet, an app, or other executable code) for causing the machine 1300 to perform any one or more of the methodologies discussed herein may be executed. For example, the instructions 1308 may cause the machine 1300 to execute any one or more of the methods described herein. The instructions 1308 transform the general, non-programmed machine 1300 into a particular machine 1300 programmed to carry out the described and illustrated functions in the manner described. The machine 1300 may operate as a standalone device or may be coupled (e.g., networked) to other machines. In a networked deployment, the machine 1300 may operate in the capacity of a server machine or a client machine in a server-client network environment, or as a peer machine in a peer-to-peer (or distributed) network environment. The machine 1300 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1308, sequentially or otherwise, that specify actions to be taken by the machine 1300. Further, while only a single machine 1300 is illustrated, the term “machine” shall also be taken to include a collection of machines that individually or jointly execute the instructions 1308 to perform any one or more of the methodologies discussed herein.

The machine 1300 may include Processors 1302, memory 1304, and I/O Components 1342, which may be configured to communicate with each other via a bus 1344. In an example embodiment, the Processors 1302 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an ASIC, a Radio-Frequency Integrated Circuit (RFIC), another Processor, or any suitable combination thereof) may include, for example, a Processor 1306 and a Processor 1310 that execute the instructions 1308. The term “Processor” is intended to include multi-core Processors that may comprise two or more independent Processors (sometimes referred to as “cores”) that may execute instructions contemporaneously. Although FIG. 13 shows multiple Processors 1302, the machine 1300 may include a single Processor with a single core, a single Processor with multiple cores (e.g., a multi-core Processor), multiple Processors with a single core, multiple Processors with multiples cores, or any combination thereof.

The memory 1304 includes a main memory 1312, a static memory 1314, and a storage unit 1316, both accessible to the Processors 1302 via the bus 1344. The main memory 1304, the static memory 1314, and storage unit 1316 store the instructions 1308 embodying any one or more of the methodologies or functions described herein. The instructions 1308 may also reside, completely or partially, within the main memory 1312, within the static memory 1314, within machine-readable medium 1318 within the storage unit 1316, within at least one of the Processors 1302 (e.g., within the Processor's cache memory), or any suitable combination thereof, during execution thereof by the machine 1300.

The I/O Components 1342 may include a wide variety of Components to receive input, provide output, produce output, transmit information, exchange information, capture measurements, and so on. The specific I/O Components 1342 that are included in a particular machine will depend on the type of machine. For example, portable machines such as mobile phones may include a touch input device or other such input mechanisms, while a headless server machine will likely not include such a touch input device. It will be appreciated that the I/O Components 1342 may include many other Components that are not shown in FIG. 13. In various example embodiments, the I/O Components 1342 may include output Components 1328 and input Components 1330. The output Components 1328 may include visual Components (e.g., a display such as a plasma display panel (PDP), a light emitting diode (LED) display, a liquid crystal display (LCD), a projector, or a cathode ray tube (CRT)), acoustic Components (e.g., speakers), haptic Components (e.g., a vibratory motor, resistance mechanisms), other signal generators, and so forth. The input Components 1330 may include alphanumeric input Components (e.g., a keyboard, a touch screen configured to receive alphanumeric input, a photo-optical keyboard, or other alphanumeric input Components), point-based input Components (e.g., a mouse, a touchpad, a trackball, a joystick, a motion sensor, or another pointing instrument), tactile input Components (e.g., a physical button, a touch screen that provides location and/or force of touches or touch gestures, or other tactile input Components), audio input Components (e.g., a microphone), and the like.

In further example embodiments, the I/O Components 1342 may include biometric Components 1332, motion Components 1334, environmental Components 1336, or position Components 1338, among a wide array of other Components. For example, the biometric Components 1332 include Components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram-based identification), and the like. The motion Components 1334 include acceleration sensor Components (e.g., accelerometer), gravitation sensor Components, rotation sensor Components (e.g., gyroscope), and so forth. The environmental Components 1336 include, for example, illumination sensor Components (e.g., photometer), temperature sensor Components (e.g., one or more thermometers that detect ambient temperature), humidity sensor Components, pressure sensor Components (e.g., barometer), acoustic sensor Components (e.g., one or more microphones that detect background noise), proximity sensor Components (e.g., infrared sensors that detect nearby objects), gas sensors (e.g., gas detection sensors to detection concentrations of hazardous gases for safety or to measure pollutants in the atmosphere), or other Components that may provide indications, measurements, or signals corresponding to a surrounding physical environment. The position Components 1338 include location sensor Components (e.g., a CPS receiver Component), altitude sensor Components (e.g., altimeters or barometers that detect air pressure from which altitude may be derived), orientation sensor Components (e.g., magnetometers), and the like.

Communication may be implemented using a wide variety of technologies. The/O Components 1342 further include communication Components 1340 operable to couple the machine 1300 to a network 1320 or devices 1322 via a coupling 1324 and a coupling 1326, respectively. For example, the communication Components 1340 may include a network interface Component or another suitable device to interface with the network 1320. In further examples, the communication Components 1340 may include wired communication Components, wireless communication Components, cellular communication Components. Near Field Communication (NFC) Components, Bluetooth® Components (e.g., Bluetooth® Low Energy), Wi-Fi® Components, and other communication Components to provide communication via other modalities. The devices 1322 may be another machine or any of a wide variety of peripheral devices (e.g., a peripheral device coupled via a USB).

Moreover, the communication Components 1340 may detect identifiers or include Components operable to detect identifiers. For example, the communication Components 1340 may include Radio Frequency Identification (RFID) tag reader Components, NFC smart tag detection Components, optical reader Components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code. UCC RSS-2D bar code, and other optical codes), or acoustic detection Components (e.g., microphones to identify tagged audio signals). In addition, a variety of information may be derived via the communication Components 1340, such as location via Internet Protocol (IP) geolocation, location via Wi-Fi® signal triangulation, location via detecting an NFC beacon signal that may indicate a particular location, and so forth.

The various memories (e.g., memory 1304, main memory 1312, static memory 1314, and/or memory of the Processors 1302) and/or storage unit 1316 may store one or more sets of instructions and data structures (e.g., software) embodying or used by any one or more of the methodologies or functions described herein. These instructions (e.g., the instructions 1308), when executed by Processors 1302, cause various operations to implement the disclosed embodiments.

The instructions 1308 may be transmitted or received over the network 1320, using a transmission medium, via a network interface device (e.g., a network interface Component included in the communication Components 1340) and using any one of a number of well-known transfer protocols (e.g., hypertext transfer protocol (HTTP)). Similarly, the instructions 1308 may be transmitted or received using a transmission medium via the coupling 1326 (e.g., a peer-to-peer coupling) to the devices 1322.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, user equipment (UE), article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computer-implemented method comprising:
accessing a first set of data from an online storage address of a third party server, the first set of data corresponding to a first floor plan of a real property;
mapping, using a trained machine learning model and optical character recognition, the first set of data to corresponding attributes of a structured data format of a query engine;
forming first structured data based on the mapped first set of data;
forming attributes of a first query using the first structured data; and
providing the first query to the query engine that is configured to generate a first quote of an insurance policy based on the attributes of the first query.

2. The computer-implemented method of claim 1, further comprising:
receiving a second set of data from a client device, the second set of data indicating selected optional features of the first floor plan of the real property;
mapping, using the trained machine learning model, the first set of data to the second set of data;
augmenting, based on the mapping, the second set of data with the first set of data; and
updating the first query with the augmented second set of data.

3. The computer-implemented method of claim 1, further comprising:
receiving a second set of data from a client device, the second set of data indicating selected optional features of the first floor plan of the real property;
mapping, using the trained machine learning model, the second set of data to the first set of data;
augmenting, based on the mapping, the first set of data with the second set of data; and
updating the first query with the augmented first set of data.

4. The computer-implemented method of claim 1, wherein the first set of data includes builder specifications of features of the first floor plan of the real property, images of the first floor plan of the real property, images of features of the first floor plan of the real property, and optional features of the first floor plan of the real property.

5. The computer-implemented method of claim 1, further comprising:
linking the first quote to the first floor plan of the real property.

6. The computer-implemented method of claim 1, further comprising:
accessing a second set of data from the online storage address of the third party server, the second set of data corresponding to a second floor plan of the real property;
mapping, using a trained machine learning model and optical character recognition, the second set of data to corresponding attributes of the structured data format of the query engine;
forming second structured data based on the mapped second set of data;
forming attributes of a second query using the second structured data;
providing the second query with the attributes to the query engine that is configured to generate a second quote of an insurance policy based on the attributes of the second query; and
linking the second quote to the second floor plan of the real property.

7. The computer-implemented method of claim 1, further comprising:
auto-populating a value in a field of the query based on the first structured data.

8. The computer-implemented method of claim 1, further comprising:
wherein the trained machine learning model is trained with data from the third party server or with data from another server associated with builders of real properties.

9. The computer-implemented method of claim 1, further comprising:
accessing a second set of data from the third party server, the second set of data indicating selected optional features of buyers of a builder;
training a second machine learning model based on the second set of data;
forming alternative attributes of the first query based on the trained second machine learning model; and
providing the alternative attributes of the first query to the query engine that is configured to generate alternative quotes of insurance policies corresponding to the alternative attributes.

10. The computer-implemented method of claim 1, further comprising:
generating metadata for the first quote, the metadata indicating the online storage address of the third party server, and the first floor plan of the real property; and
appending the metadata to the first quote.

11. A computing apparatus comprising:
a processor; and
a memory storing instructions that, when executed by the processor, configure the apparatus to:
access a first set of data from an online storage address of a third party server, the first set of data corresponding to a first floor plan of a real property;
map, using a trained machine learning model and optical character recognition, the first set of data to corresponding attributes of a structured data format of a query engine;
form first structured data based on the mapped first set of data;
form attributes of a first query using the first structured data; and
provide the first query to the query engine that is configured to generate a first quote of an insurance policy based on the attributes of the first query.

12. The computing apparatus of claim 11, wherein the instructions further configure the apparatus to:
receive a second set of data from a client device, the second set of data indicating selected optional features of the first floor plan of the real property;
map, using the trained machine learning model, the first set of data to the second set of data;
augment, based on the mapping, the second set of data with the first set of data; and
update the first query with the augmented second set of data.

13. The computing apparatus of claim 11, wherein the instructions further configure the apparatus to:
receive a second set of data from a client device, the second set of data indicating selected optional features of the first floor plan of the real property;
map, using the trained machine learning model, the second set of data to the first set of data;
augment, based on the mapping, the first set of data with the second set of data; and
update the first query with the augmented first set of data.

14. The computing apparatus of claim 11, wherein the first set of data includes builder specifications of features of the first floor plan of the real property, images of the first floor plan of the real property, images of features of the first floor plan of the real property, and optional features of the first floor plan of the real property.

15. The computing apparatus of claim 11, wherein the instructions further configure the apparatus to:
link the first quote to the first floor plan of the real property.

16. The computing apparatus of claim 11, wherein the instructions further configure the apparatus to:
access a second set of data from the online storage address of the third party server, the second set of data corresponding to a second floor plan of the real property;
map, using a trained machine learning model and optical character recognition, the second set of data to corresponding attributes of the structured data format of the query engine;
form second structured data based on the mapped second set of data;
form attributes of a second query using the second structured data;
provide the second query with the attributes to the query engine that is configured to generate a second quote of an insurance policy based on the attributes of the second query; and
link the second quote to the second floor plan of the real property.

17. The computing apparatus of claim 11, wherein the instructions further configure the apparatus to:
auto-populate a value in a field of the query based on the first structured data.

18. The computing apparatus of claim 11, wherein the instructions further configure the apparatus to:
wherein the trained machine learn model is trained with data from the third party server or with data from another server associated with builders of real properties.

19. The computing apparatus of claim 11, wherein the instructions further configure the apparatus to:
access a second set of data from the third party server, the second set of data indicating selected optional features of buyers of a builder;
train a second machine learning model based on the second set of data;
form alternative attributes of the first query based on the trained second machine learning model; and
provide the alternative attributes of the first query to the query engine that is configured to generate alternative quotes of insurance policies corresponding to the alternative attributes.

20. A non-transitory computer-readable storage medium, the computer-readable storage medium including instructions that when executed by a computer, cause the computer to:
access a first set of data from an online storage address of a third party server, the first set of data corresponding to a first floor plan of a real property;
map, using a trained machine learning model and optical character recognition, the first set of data to corresponding attributes of a structured data format of a query engine;
form first structured data based on the mapped first set of data;
form attributes of a first query using the first structured data; and
provide the first query to the query engine that is configured to generate a first quote of an insurance policy based on the attributes of the first query.
